(19) United States
(12) Patent Application Publication
(10) Pub. No.: US 2026/0135016 A1
(43) Pub. Date: May 14, 2026

(54) WIRING AND ELECTRONIC APPARATUS

(71) Applicant: SONY SEMICONDUCTOR SOLUTIONS CORPORATION, KANAGAWA (JP)

(72) Inventor: Yasuhiro OCHIAI, KANAGAWA (JP)

(21) Appl. No.: 19/118,353

(22) PCT Filed: Aug. 17, 2023
(86) PCT No.: PCT/JP2023/029673

§ 371 Date: Apr. 3, 2025

(30) Foreign Application Priority Data
Oct. 11, 2022 (JP) 2022-163363

(51) Int. Cl. H01B 7/30

(52) U.S. Cl. CPC H01B 7/30

(57) ABSTRACT

A wiring according to the present disclosure includes a plurality of division wirings, each of which allows an alternating current to flow through. The plurality of division wirings is configured such that the number of divisions of wirings is equal to or more than four. When Sp is an interwire space between two adjacent division wirings of the division wirings and Wd is an individual wiring width of each of the plurality of division wirings, Sp/Wd falls in a range of not less than 0.2 and not more than 0.55 in a case where an opposite-phase current is caused to flow through the plurality of division wirings as the alternating current, and Sp/Wd falls in a range of not less than 0.35 and not more than 0.95 in a case where an in-phase current is caused to flow through the plurality of division wirings as the alternating current.

### TECHNICAL FIELD

The present disclosure relates to a wiring and an electronic apparatus.

### BACKGROUND ART

In a case of wirings made of copper or the like, as the frequency of flowing current increases, the current concentrates on the surface of the wiring, which leads to an increase in the resistance. This is called a skin effect. As a technique of reducing the resistance of a wiring through which a high frequency current flows, there is proposed a technique having a configuration in which the wiring is divided into a plurality of lines (see Patent Literature 1).

### CITATION LIST

### Patent Literature

PTL 1: Japanese Unexamined Patent Application Publication No. 2003-229705

### SUMMARY OF THE INVENTION

As the resistance increases due to the skin effect, a loss of effective electric power increases, which leads to an increase in the generated heat or a voltage drop. The technique described in Patent Literature 1 does not sufficiently optimize the configuration parameters in connection with dividing the wiring into plural wirings. The configuration parameters include the number of divisions of wirings, the wiring width, the interwire space, or the like. Thus, the technique does not provide sufficient effects of suppressing an increase in the resistance in a high-frequency range.

It is desirable to provide a wiring and an electronic apparatus that make it possible to reduce the resistance in a high-frequency range due to the skin effect.

A wiring according to an embodiment of the present disclosure includes a plurality of division wirings, each of which allows an alternating current to flow through, in which the number of divisions of the plurality of division wirings is equal to four, and when Sp is an interwire space between two adjacent division wirings of the division wirings and Wd is an individual wiring width of each of the plurality of division wirings, and Sp/Wd falls in a range of not less than 0.2 and not more than 0.55 in a case where an opposite-phase current is caused to flow through the plurality of division wirings as the alternating current, and Sp/Wd falls in a range of not less than 0.35 and not more than 0.95 in a case where an in-phase current is caused to flow through the plurality of division wirings as the alternating current.

An electronic apparatus according to an embodiment of the present disclosure includes a wiring including a plurality of division wirings, each of which allows an alternating current to flow through, in which the number of divisions of the plurality of division wirings is equal to or more than four, and when Sp is an interwire space between two adjacent division wirings of the division wirings and Wd is an individual wiring width of each of the plurality of division wirings, Sp/Wd falls in a range of not less than 0.2 and not more than 0.55 in a case where an opposite-phase current is caused to flow through the plurality of division wirings as the alternating current, and Sp/Wd falls in a range of not less than 0.35 and not more than 0.95 in a case where an in-phase current is caused to flow through the plurality of division wirings as the alternating current.

In the wiring and the electronic apparatus according to the embodiment of the present disclosure, the plurality of division wirings is optimized so as to be able to reduce an increase in the resistance due to the skin effect.

### BRIEF DESCRIPTION OF DRAWINGS

FIG. 1 is a characteristic view of one example of distribution of an alternating current at and around a typical conductor.

FIG. 2 is a perspective view of one example of a wiring including a typical conductor.

FIG. 3 is a characteristic view of one example of a typical relationship between skin depth and frequency.

FIG. 4 is a characteristic view of results of calculation of direct-current resistances and alternating-current resistances obtained through manual calculation.

FIG. 5 is a characteristic view in which results of calculation of the sum of direct-current resistance and alternating-current resistance through simulation using electromagnetic field analysis is compared with calculation through manual calculation.

FIG. 6 is a characteristic view of results of calculation of direct-current resistances and alternating-current resistances through manual calculation and simulation using electromagnetic field analysis.

FIG. 7 is a characteristic view of results of calculation of direct-current resistances and alternating-current resistances through manual calculation and simulation using electromagnetic field analysis.

FIG. 8 is a characteristic view of results of comparison of the impedance between alternating-current resistance and inductance.

FIG. 9 is a characteristic view of one example of consumption of the current caused to flow through a wiring.

FIG. 10 is a characteristic view of one example of voltage drop in three types of wirings having different impedance properties.

FIG. 11 is a characteristic view of results obtained by calculating effective electric power generated in individual wirings having three types of impedance properties.

FIG. 12 is an explanatory view of an average loss of effective electric power calculated on the basis of a result of calculation in FIG. 11.

FIG. 13 is an explanatory view of one example of a method of reducing the alternating-current resistance without changing the direct-current resistance.

FIG. 14 is a characteristic view of results of simulation, through electromagnetic field analysis, for the frequency property of a resistance in a case where a ratio between the wiring width and the wiring thickness is varied with the cross-sectional area of the wiring being constant.

FIG. 15 is an explanatory view of one example of the direct-current resistance and the alternating-current resistance in a case where the wiring is divided.

FIG. 16 is a characteristic view of results of simulation, using electromagnetic field analysis, for the resistance value of each wiring in a case where an in-phase current is caused to flow through two division wirings and the interwire space is varied.

FIG. 17 is a characteristic view of results of simulation, using electromagnetic field analysis, for the resistance value of each wiring in a case where an opposite-phase current is caused to flow through two division wirings and the interwire space is varied.

FIG. 18 is a characteristic view of results of simulation, using electromagnetic field analysis, for the distribution of magnetic fields in the cross section of the wiring in a case where an in-phase current is caused to flow through two division wirings.

FIG. 19 is a characteristic view of results of simulation, using electromagnetic field analysis, for the distribution of magnetic fields in the cross section of the wiring in a case where an in-phase current is caused to flow through two division wirings.

FIG. 20 is a characteristic view of results of simulation, using electromagnetic field analysis, for the distribution of magnetic fields in the cross section of the wiring in a case where an opposite-phase current is caused to flow through two division wirings.

FIG. 21 is a characteristic view of results of simulation, using electromagnetic field analysis, for the distribution of magnetic fields in the cross section of the wiring in a case where an opposite-phase current is caused to flow through two division wirings.

FIG. 22 is a cross-sectional view of a plurality of configuration examples in which the area of cross-section of each of two division wirings is constant and a ratio between the wiring width and the wiring thickness is varied.

FIG. 23 is a characteristic view of results of simulation for resistances in terms of the frequency property using electromagnetic field analysis for each of the configuration examples illustrated in FIG. 22.

FIG. 24 is a characteristic view of results of simulation for resistances in terms of the frequency property using electromagnetic field analysis for each of the configuration examples illustrated in FIG. 22.

FIG. 25 is a configuration diagram illustrating an example in which a wiring is divided into four division wirings.

FIG. 26 is a configuration diagram schematically illustrating wiring models used in calculation of resistances.

FIG. 27 is a characteristic view of results of calculation of resistances through manual calculation and simulation using electromagnetic field analysis on the basis of the wiring models in FIG. 26.

FIG. 28 is a characteristic view of results of calculation for resistances through manual calculation and simulation using electromagnetic field analysis on the basis of the wiring models in FIG. 26.

FIG. 29 is a characteristic view of results of calculation for resistances through manual calculation and simulation using electromagnetic field analysis on the basis of the wiring models in FIG. 26.

FIG. 30 is an explanatory view of the configuration examples of division wirings in which the ratio (Sp/Wd) between the interwire space Sp and the individual wiring width Wd is varied.

FIG. 31 is an explanatory view of the outline of a method of calculating an optimum value of Sp/Wd for reducing the alternating-current resistance on the basis the relationship between the number of divisions of wirings, the interwire space, the individual wiring width, and the wiring thickness.

FIG. 32 is an explanatory view of examples of calculation of the number of divisions of wirings and the rate of increase in the routing resource with the routing resource in the width direction being taken into consideration.

FIG. 33 is an explanatory view of examples of calculation of the number of divisions of wirings and the rate of increase in the routing resource with the routing resource in the width direction being taken into consideration.

FIG. 34 is an explanatory view of one example of results of calculation of the rate of increase in the resistance.

FIG. 35 is an explanatory view of one example of results of calculation of multiplying the inverse of the rate of increase in the routing resource by the rate of increase in the resistance.

FIG. 36 is an explanatory view of one example of the relationship between the optimum number N of divisions of wirings, the value of Sp/Wd, and the value of Wd/t in a case where an opposite-phase current is caused to flow.

FIG. 37 is an explanatory view of one example of the relationship between the optimum number N of divisions of wirings, the value of Sp/Wd, and the value of Wd/t in a case where an in-phase current is caused to flow.

FIG. 38 is a configuration diagram illustrating a first application example in which the wiring according to the embodiment is applied to an electronic apparatus.

FIG. 39 is a configuration diagram illustrating a second application example in which the wiring according to the embodiment is applied to an electronic apparatus.

FIG. 40 is a configuration diagram illustrating a third application example in which the wiring according to the embodiment is applied to an electronic apparatus.

### MODES FOR CARRYING OUT THE INVENTION

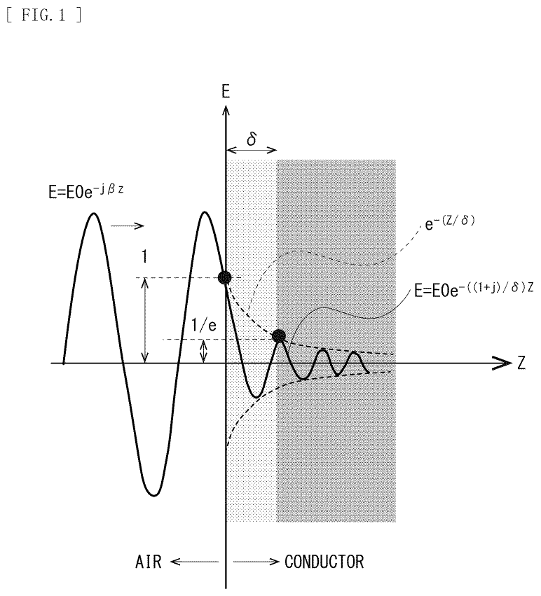

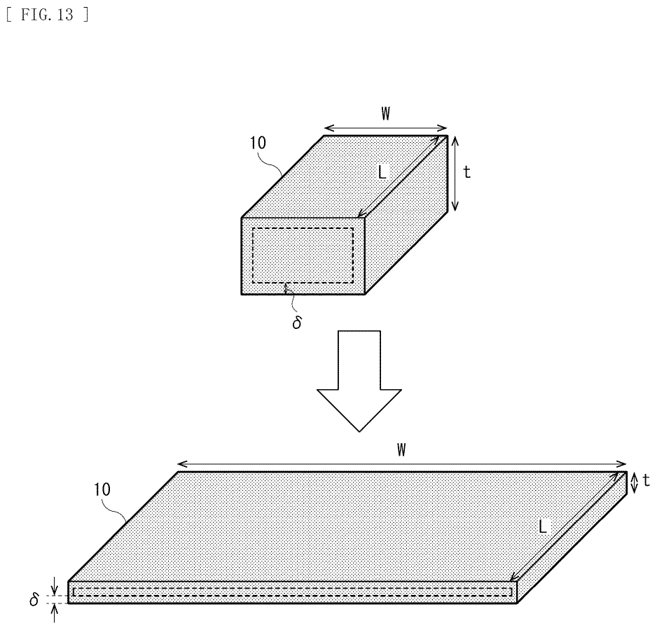

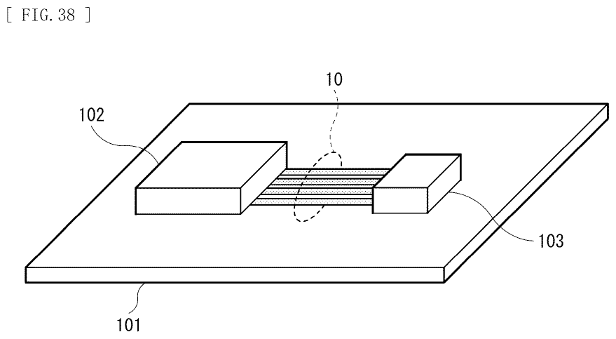

Below, embodiment according to the present disclosure will be described in detail with reference to the drawings. Note that description will be made in the following order.
1. Embodiment
   1.1 Background (FIGS. 1 to 12)
   1.2 Structure of wirings in which the skin effect is taken into consideration (FIGS. 13 to 37)
      1.2.1 Method of reducing alternating-current resistance
      1.2.2 Expression used to calculate alternating-current resistance while considering interwire space
      1.2.3 Method of efficiently determining the number of divisions of wirings
   1.3 Application Examples (FIGS. 38 to 40)
   1.4 Effects
2. Other embodiments

### 1. Embodiment

### [1.1 Background]

### (About Skin Effect)

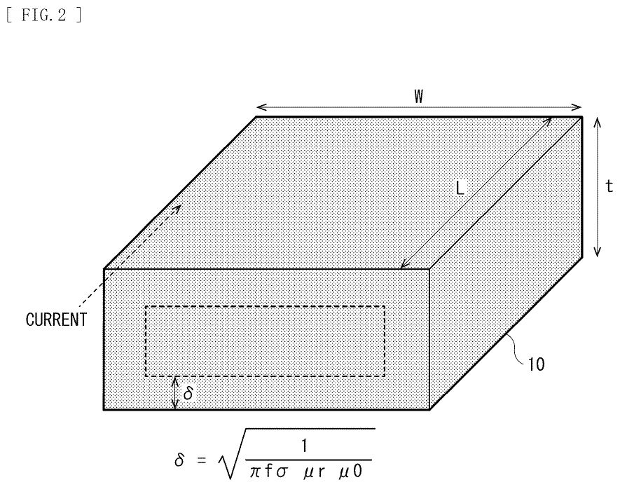

FIG. 1 illustrates one example of the distribution of an alternating current at and around a typical conductor. FIG. 2 illustrates one example of a wiring 10 including the conductor.

The horizontal axis of FIG. 1 indicates the position Z from the front surface of the conductor with the front surface of the conductor being the reference position (Z=0). The vertical axis of FIG. 1 indicates the electric field E. The electric field E is expressed by the following Equation (1) in the air, and is expressed by the Equation (2) in the conductor. E0 is an amplitude constant. “j” is an imaginary unit. “β” is a phase constant. “δ” represents a skin depth (skin thickness). Note that, in the conductor, a current flows in the same direction as the electric field E. The depth (thickness) at which the electric current value is 1/e relative to the electric current value at the front surface of the conductor is called the skin depth (skin thickness).

$$\begin{matrix}[ Formula 1 ] & \\ E = E 0 {e}^{- j β Z} & ( 1 )\end{matrix}$$

$$\begin{matrix}[ Formula 2 ] & \\ E = E 0 {e}^{- ( ( 1 + j ) / δ ) Z} & ( 2 )\end{matrix}$$

When an alternating current is caused to flow through the conductor, a phenomenon called the skin effect occurs. With this skin effect, a current concentrates more on the front surface of the conductor as the frequency f of the alternating current increases. Thus, as the frequency f increases, the alternating-current resistance of the conductor increases. The skin depth (skin thickness) δ is expressed by following Equation (3). Each of the parameters in Equation (3) represents the followings.
δ: skin depth (skin thickness) (m)
f: frequency (Hz) of alternating current
σ: electric conductivity (S/m) of conductor
μr: relative magnetic permeability of conductor
μ0: vacuum magnetic permeability (H/m)

$$\begin{matrix}[ Formula 3 ] & \\ δ = \sqrt{\frac{1}{π f σμ r μ0}} & ( 3 )\end{matrix}$$

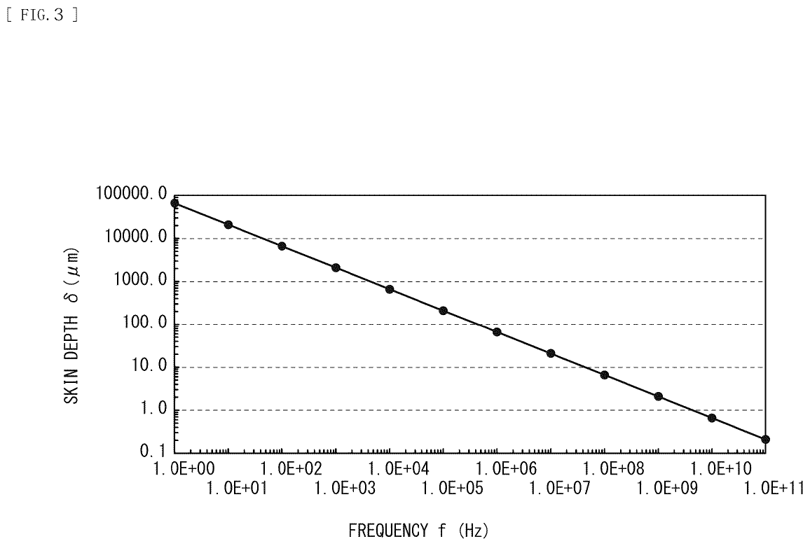

FIG. 3 illustrates one example of the relationship between the skin depth δ (vertical axis) and the frequency f (horizontal axis) in a typical conductor.

FIG. 3 is an example in a case where the conductor is made of copper (Copper). If the frequency f of the alternating current exceeds 1 GHz, the skin depth δ turns into the order of μm. If the frequency f becomes high, even when an alternating current is caused to flow through the conductor, the alternating current only flows through the surface of the conductor.

### (About Resistance of Conductor)

It is possible to separate the resistance of a conductor into the direct-current resistance Rdc and the alternating-current resistance Rac, and consider them. The direct-current resistance Rdc and the alternating-current resistance Rac are expressed in the following manner, where W is the width (wiring width) of a wiring (conductor) 10 through which the current flows, t is the thickness (wiring thickness) of the wiring 10, and L is the length (wiring length) of the wiring 10, as illustrated in FIG. 2.

$$Rdc = ( 1 / σ Wt ) \cdot L$$

$$Rac = ( 1 / 2 σδ ( W + t ) ) \cdot L$$

The direct-current resistance Rdc is irrelevant to the frequency f. The alternating-current resistance Rac is inversely proportional to the skin depth δ, and increases with increase in the frequency f. As can be understood from FIG. 3, the skin depth δ reduces so as to be proportional to the square root of the frequency f.

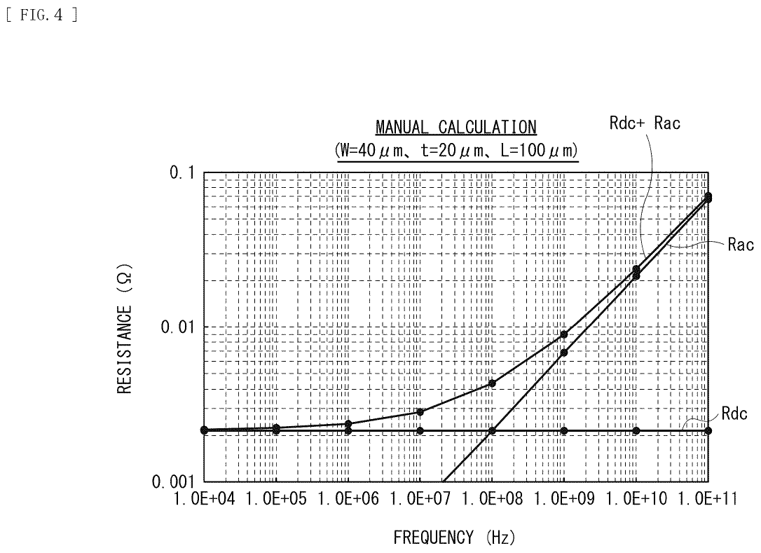

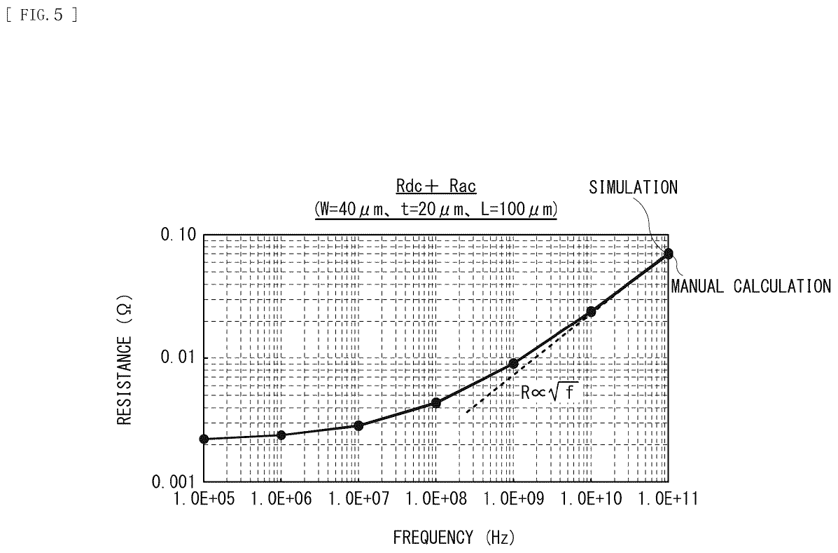

FIG. 4 shows results obtained by calculating the direct-current resistance Rdc and the alternating-current resistance Rac through manual calculation, and further calculating the sum of the direct-current resistance Rdc and the alternating-current resistance Rac. FIG. 5 shows that results of calculation of the sum of the direct-current resistance Rdc and the alternating-current resistance Rac through simulation using electromagnetic field analysis are compared with results through manual calculation. FIGS. 4 and 5 show results obtained by using copper as the conductive material of the wiring 10, and setting the shape of the wiring to the wiring width W=40 μm, the wiring thickness t=20 μm, and the wiring length L=100 μm. As can be understood from FIG. 5, the results obtained through simulation and the results obtained through manual calculation substantially match each other.

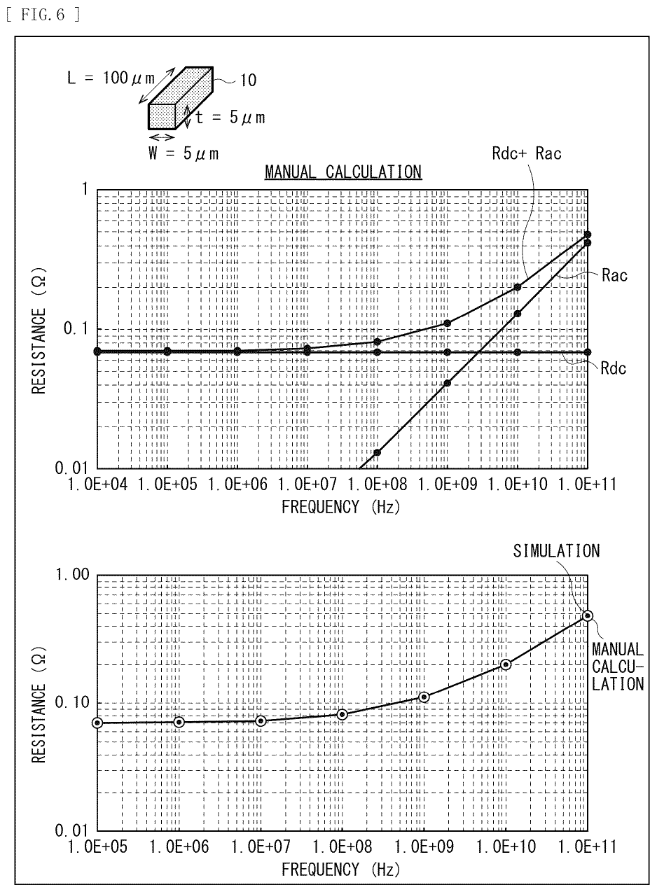

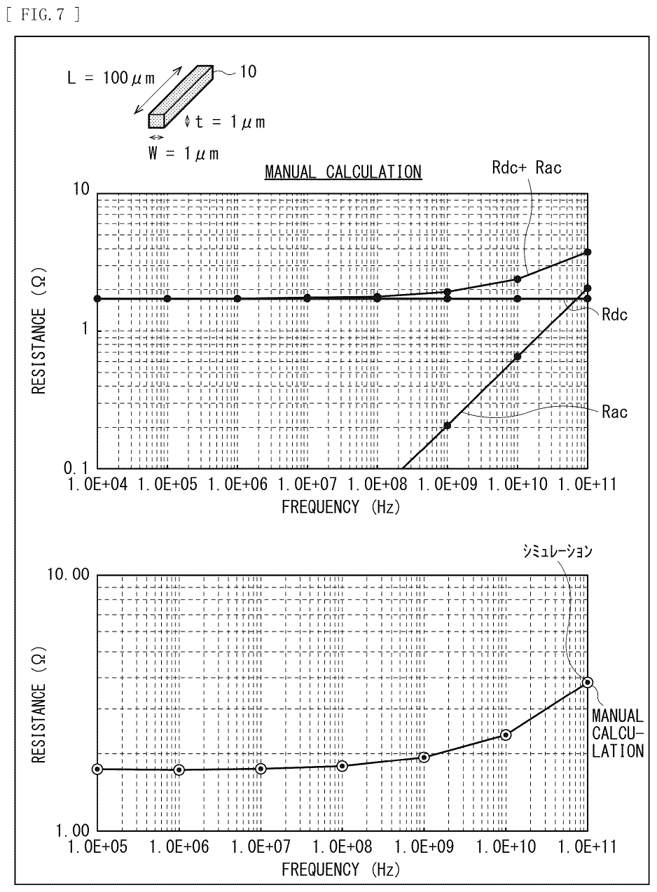

FIGS. 6 and 7 show results of calculation in a case where the shape of the wiring is changed from that in FIGS. 4 and 5. FIGS. 6 and 7 show results of calculation of the direct-current resistance Rdc and the alternating-current resistance Rac through manual calculation and simulation using electromagnetic field analysis. FIG. 6 shows results obtained by using copper as the conductive material of the wiring 10, and setting the shape of the wiring to the wiring width W=5 μm, the wiring thickness t=5 μm, and the wiring length L=100 μm. FIG. 7 shows results obtained by using copper as the conductive material of the wiring 10, and setting the shape of the wiring to the wiring width W=1 μm, the wiring thickness t=1 μm, and the wiring length L=100 μm. As can be understood from FIGS. 6 and 7, the results obtained through simulation and the results obtained through manual calculation substantially match each other even in a case where the shape of the wiring is varied.

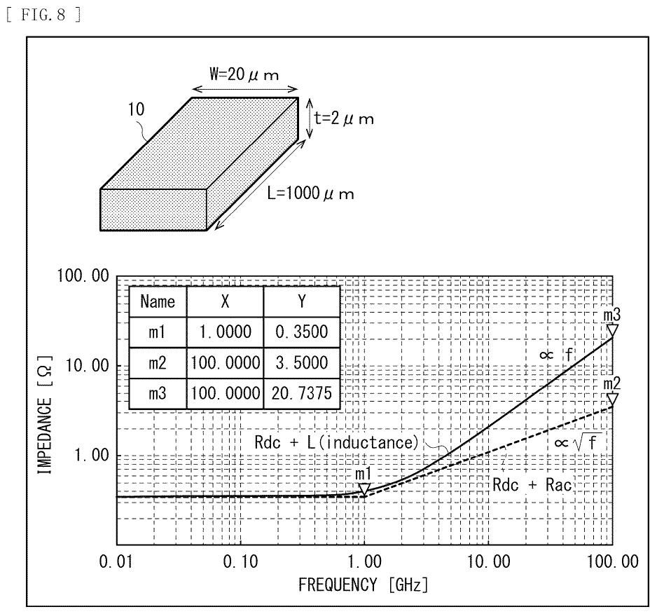

FIG. 8 shows results obtained by comparing the impedance between the alternating-current resistance Rac and L (inductance).

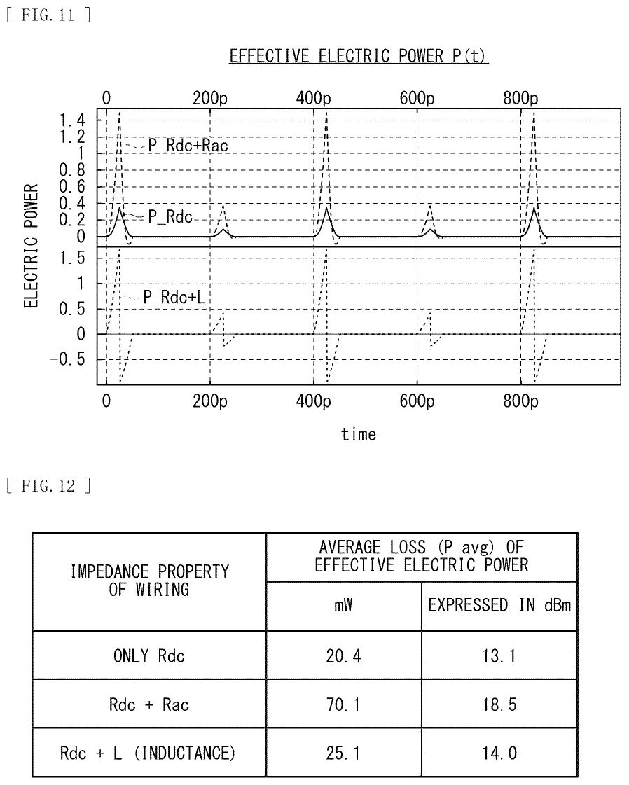

In order to determine the influence of the alternating-current resistance Rac, wirings 10 having three types of impedance properties were used, and a current was caused to flow through the wirings 10 having these impedance properties to calculate the electric power through simulation (FIG. 11 that will be described later). FIG. 8 shows two impedance properties of the three types of impedance properties. One of them is an impedance property relating to the sum (Rdc+Rac) of the direct-current resistance Rdc and the alternating-current resistance Rac, and has a resistance property corresponding to the wiring 10 having the wiring width W=20 μm, the wiring thickness t=2 μm, and the wiring length L=1000 μm. Another one of them is an impedance property relating to the sum (Rdc+L) of the direct-current resistance Rdc and the inductance L, and the value of the inductance L is set to L=33 pH. Both of them have the same value of direct-current resistance Rdc, the value being 0.35Ω. In a case of both properties, the frequency f at which the impedance starts to increase is almost the same. In terms of the increase in the impedance, the property of Rdc+Rac exhibits a property that is proportional to the square root of the frequency f, and the property of Rdc+L exhibits a property that is proportional to the frequency f.

### (About Current and Voltage Drop)

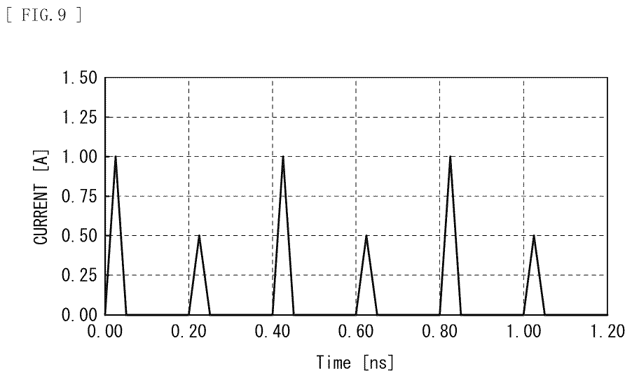

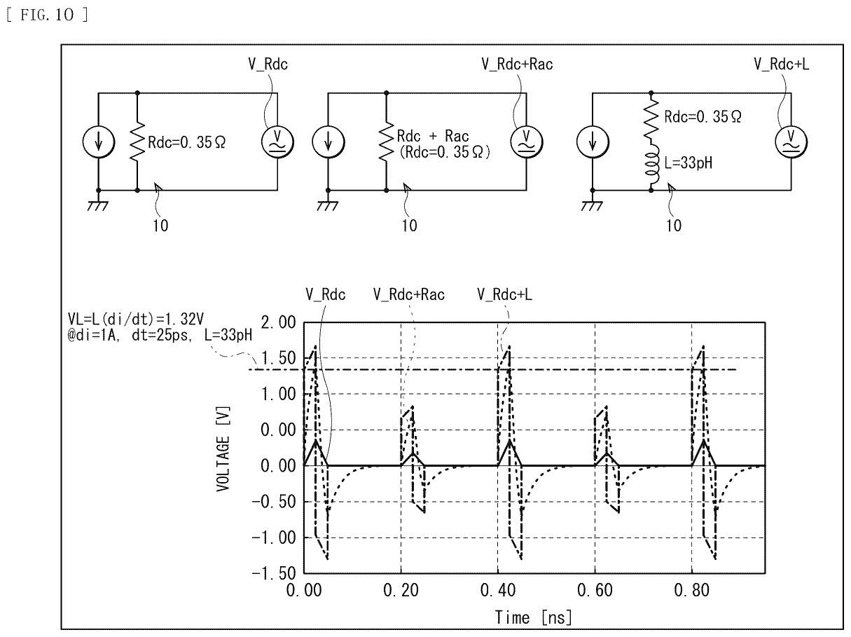

FIG. 9 shows one example of the consumption of current flowing through the wiring 10. FIG. 10 shows one example of voltage drop of three types of wirings 10 having different impedance properties.

For the consumption of current, two types of |di/dt|=1 A/25 ps and 0.5 A/25 ps that are alternately generated on the axis of time are used, as illustrated in FIG. 9. The cycle of generation of the current is 0.4 ns, which corresponds to the operation frequency of 250 MHz. This consumption of current was caused to flow through the following three types of wirings 10 having different impedance properties. As illustrated in FIG. 10, the voltage of the property 1 is set to V_Rdc, the voltage of the property 2 is set to V_Rdc+Rac, and the voltage of the property 3 is set to V_Rdc+L.
property 1: only Rdc
property 2: Rdc+Rac
property 3: Rdc+L

The voltage generated across both ends of each of the wirings 10 having the properties described above is simulated, and is monitored. As illustrated in FIG. 10, the high-low relationship of the voltage drop of each of the properties described above is given in the following manner. During operation in a high frequency band, the voltage drop occurs more significantly in the alternating-current resistance Rac than in the direct-current resistance Rdc.
(property 3)>(property 2)>(property 1)

FIG. 11 shows results of calculation of the effective electric power P(t) generated in each of the wirings 10 having three types of impedance properties described above. FIG. 12 shows the average loss P_avg of effective electric power calculated on the basis of the results of calculation in FIG. 11. The effective electric power P(t) of the property 1 is referred to as P_Rdc. The effective electric power P(t) of the property 2 is referred to as P_Rdc+Rac. The effective electric power P(t) of the property 3 is referred to as P_Rdc+L.

The effective electric power P(t) and the average loss P_avg of effective electric power are expressed in the following manner.

$$P ( t ) = re \{ V\_R ( t ) \times I ( t ) \}$$

$$P\_avg = average ( P ( t ) )$$

FIG. 12 shows results obtained by taking out the real-part term {V_R(t)×I(t)} of the effective electric power P(t) relative to the electric power on the axis of time to obtain the average loss-effective electric power P_avg. The loss of the effective electric power P(t) caused by the alternating-current resistance Rac is two or more times greater than that caused by the direct-current resistance Rdc. In addition, the alternating-current resistance Rac plays a dominant role in generation of heat from the conductor serving as the wiring 10. In a case of operation at high frequency f, it is significantly important to reduce the alternating-current resistance Rac of the wiring 10.

[1.2 Structure of Wiring in which Skin Effect is Taken into Consideration]

### (1.2.1 Method of Reducing Alternating-Current Resistance)

FIG. 13 shows one example of a method of reducing the alternating-current resistance Rac without changing the direct-current resistance Rdc.

As described above, the direct-current resistance Rdc and the alternating-current resistance Rac are expressed in the following manner, where W is the wiring width, t is the wiring thickness, Lis the wiring length, δ is the skin depth, and σ is the electric conductivity of the wiring (conductor) 10.

$$Rdc = ( 1 / σ Wt ) \cdot L$$

$$Rac = ( 1 / 2 σδ ( W + t ) ) \cdot L$$

The size of the alternating-current resistance Rac largely depends on the shape of the wiring thereof. In order to reduce the alternating-current resistance Rac without changing the direct-current resistance Rdc, it is only necessary to increase the surface area with the area (W×t) of cross-section being constant, as illustrated in FIG. 13, for example.

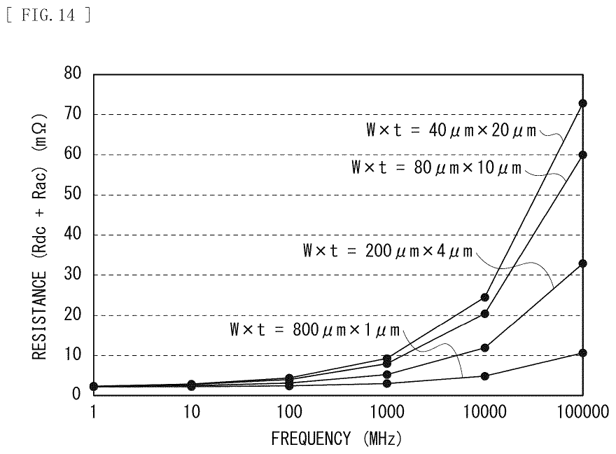

FIG. 14 shows results of simulation for the frequency property of a resistance in a case where the ratio between the wiring width W and the wiring thickness t is varied with the area (W×t) of cross-section of the wiring 10 being constant (W×t=800 (μm²)). The horizontal axis indicates frequency f, and the vertical axis indicates resistance (Rdc+Rac).

From the results in FIG. 14, it can be understood that, by devising the shape of the wiring so as to increase the surface area, it is possible to reduce the alternating-current resistance Rac.

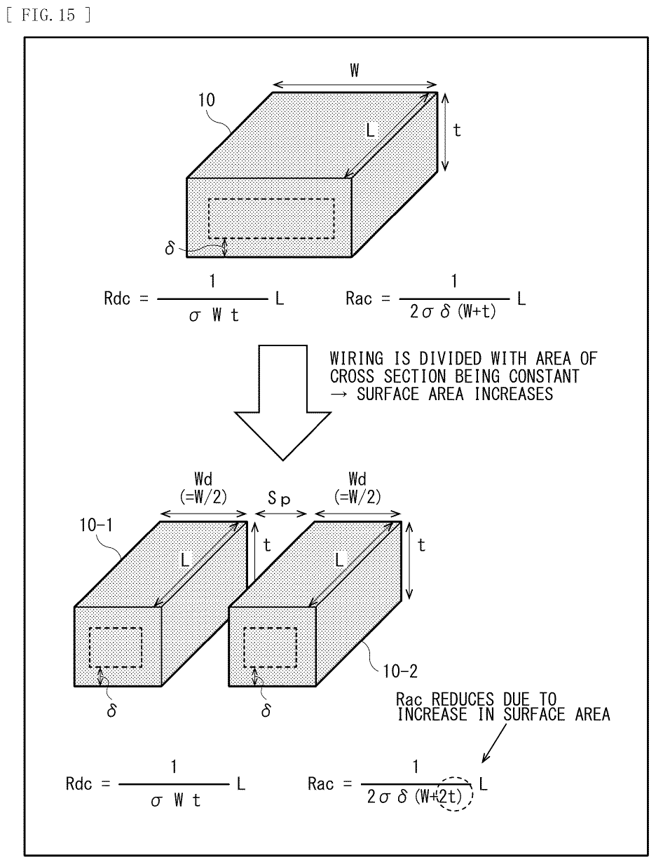

FIG. 15 shows one example of the direct-current resistance Rdc and the alternating-current resistance Rac in a case where the wiring 10 is divided.

As described above, in order to increase the surface area with the area (W×t) of cross section of the wiring 10 being constant, it is only necessary to divide the wiring 10 into a plurality of pieces as illustrated in FIG. 15. However, dividing the wiring 10 into a plurality of pieces necessitates an interwire space Sp between two adjacent division wirings, which leads to an increase in the routing resource. The “routing resource” as used herein means a wiring region used to configure the wiring 10. The configuration example in the lower section of FIG. 15 shows the configuration example in which the wiring 10 is divided into two division wirings 10-1 and 10-2 with the interwire space Sp being interposed. In the configuration example in the lower section of FIG. 15, the individual wiring width Wd of each of the two division wirings 10-1 and 10-2 is set to ½ of the wiring width W of the wiring 10 before division illustrated in the upper section of FIG. 15 (Wd=W/2). In the configuration example in the lower section of FIG. 15, the routing resource of the wiring 10 increases in the width direction by the amount corresponding to the interwire space Sp relative to the wiring 10 before division. In this case, the direct-current resistance Rdc and the alternating-current resistance Rac of the wiring 10 after division is expressed in the following manner.

$$Rdc = ( 1 / σ Wt ) \cdot L$$

$$Rac = ( 1 / 2 σδ ( W + t ) ) \cdot L$$

In order to reduce the alternating-current resistance Rac while avoiding increasing the routing resource in the width direction as much as possible, theoretically, it is only necessary to determine the wiring width W, the wiring thickness t, and the number N of divisions of wirings so as to satisfy (A+B)>(C+D) in following Equations (4) and (5). Note that, in Equation (5), the interwire space Sp generated due to the number N of divisions of wirings is set to the same value as the wiring width W.

$$\begin{matrix}[ Formula 4 ] & \\ A + B = {[ \frac{1}{σ Wt}}^{A term} + {\frac{1}{2 σδ ( W + t )} ]}^{B term} & ( 4 )\end{matrix}$$

$$C + D = {[ \frac{1}{σ ( Wt - Wt N / ( 2 N + 1 )}}^{C term} + {\frac{1}{2 δσ ( W + t - WN / ( 2 N + 1 ) + Nt )} ]}^{D term} \qquad ( 5 )$$

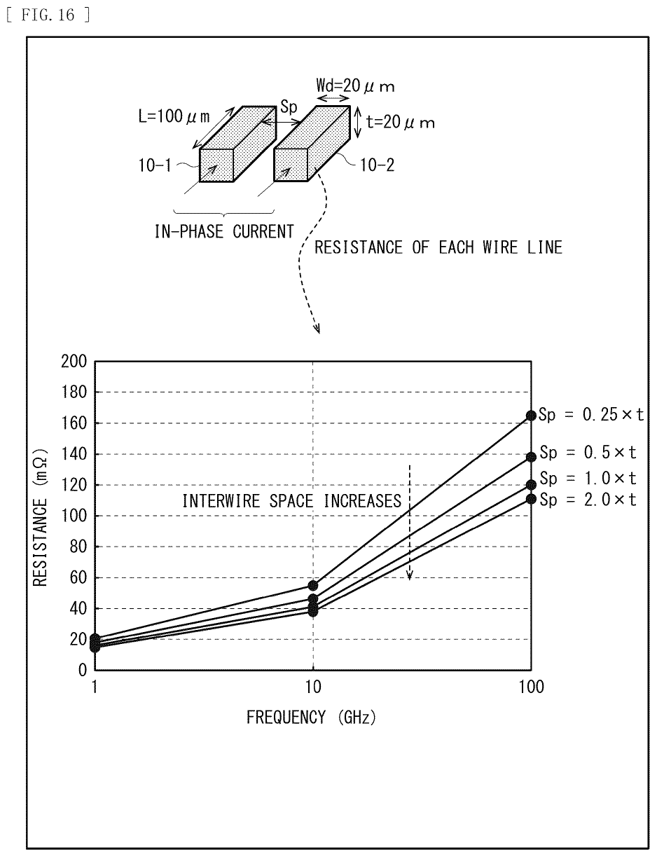

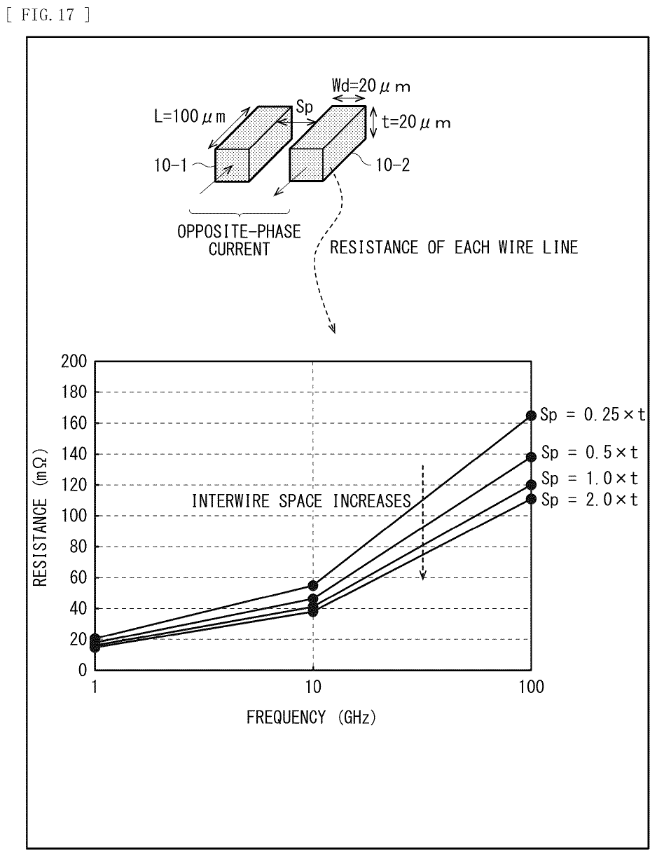

FIG. 16 shows results of simulation, using electromagnetic field analysis, for the resistance value of each wiring in a case where an in-phase current is caused to flow through two division wirings 10-1 and 10-2 and the interwire space Sp is varied. FIG. 17 shows results of simulation, using electromagnetic field analysis, for the resistance value of each wiring in a case where an opposite-phase current is caused to flow through two division wirings 10-1 and 10-2 and the interwire space Sp is varied. In FIGS. 16 and 17, the horizontal axis indicates the frequency f and the vertical axis indicates the resistance (Rdc+Rac). FIGS. 16 and 17 illustrate characteristics in a case where the wiring 10 is divided into two division wirings 10-1 and 10-2 with the interwire space Sp being interposed between them. FIGS. 16 and 17 illustrate results obtained by using copper as the conductive material of the division wirings 10-1 and 10-2, and setting the shape of the wiring to the wiring width Wd=20 μm, the wiring thickness t=20 μm, and the wiring length L=100 μm.

The expression (A+B)>(C+D) described above establishes if the alternating-current resistance Rac does not depend on the interwire space Sp at the time of dividing the wiring 10. However, in reality, this does not apply. By increasing the interwire space Sp generated due to division, the alternating-current resistance Rac tends to reduce.

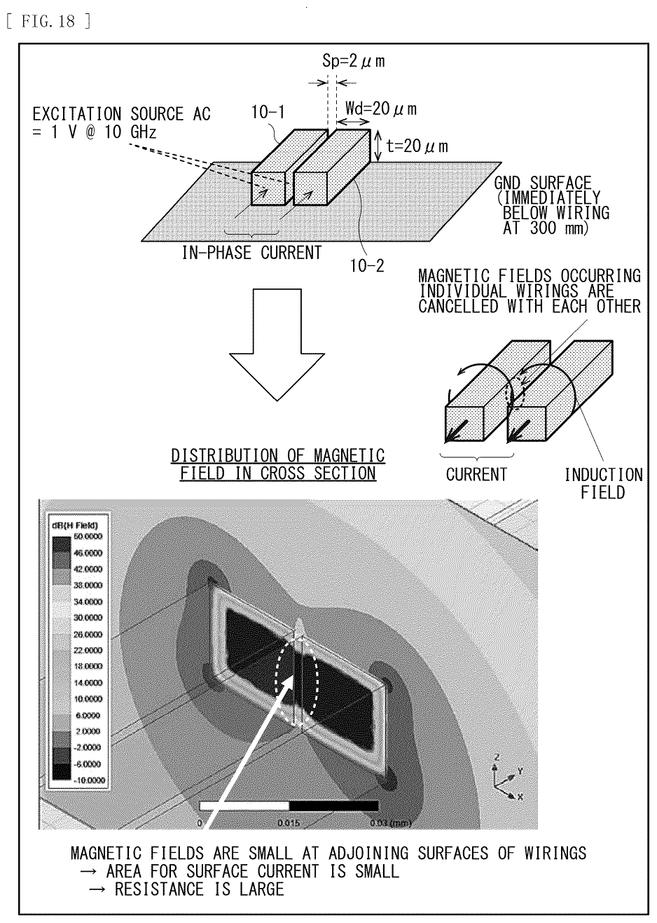

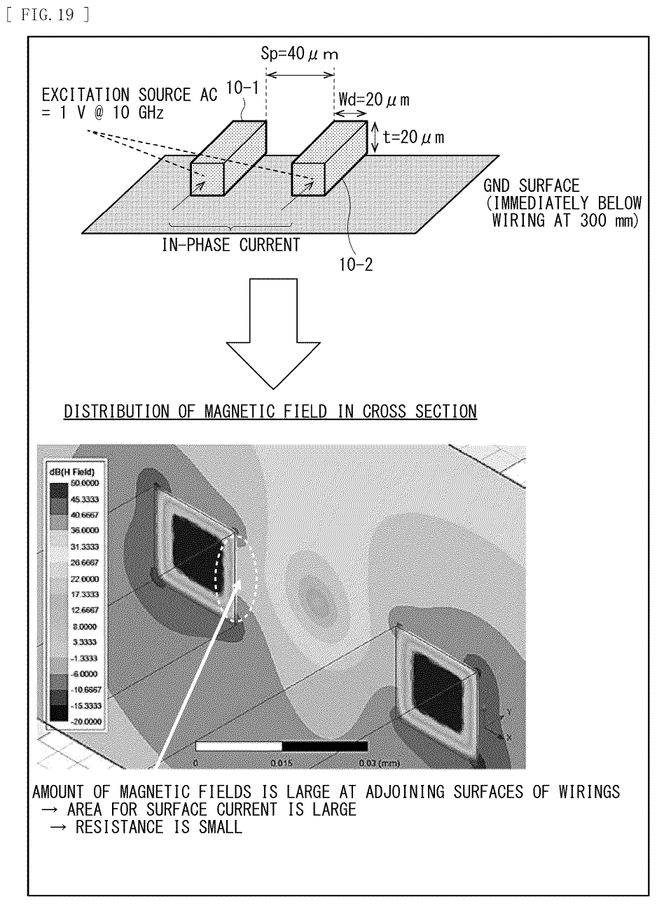

FIGS. 18 and 19 show results of simulation, using electromagnetic field analysis, for the distribution of magnetic field in the cross-section of the wiring in a case where an in-phase current is caused to flow through two division wirings 10-1 and 10-2. FIG. 18 shows results in a case where the interwire space Sp is set to 2 μm. FIG. 19 shows results in a case where the interwire space Sp is set to 40 μm. In the simulation, a reference GND (ground) is disposed immediately below the wiring at 300 μm. Two division wirings 10-1 and 10-2 having the wiring width Wd=20 μm and the wiring thickness t=20 μm are disposed above the GND (ground), and an in-phase current is applied by setting an excitation source to a potential difference of AC voltage AC=1 V and the frequency f=10 GHz.

In a case where the in-phase current is caused to flow through the two division wirings 10-1 and 10-2, magnetic fields are generated by these wirings, and these magnetic fields cancel each other. As these two division wirings 10-1 and 10-2 are disposed closer to each other, the effect of cancelling the magnetic fields becomes more pronounced, and the current is less likely to flow at adjoining surfaces of the division wirings 10-1 and 10-2. If the interwire space Sp is small as illustrated in FIG. 18, magnetic fields reduce between the wirings, and the area for the surface current reduces. This results in an increase in the resistance. In contrast, if the interwire space Sp increases as illustrated in FIG. 19, this phenomenon becomes less pronounced. In addition, magnetic fields increase between the wirings, and the area for the surface current increases. This results in a reduction in the resistance.

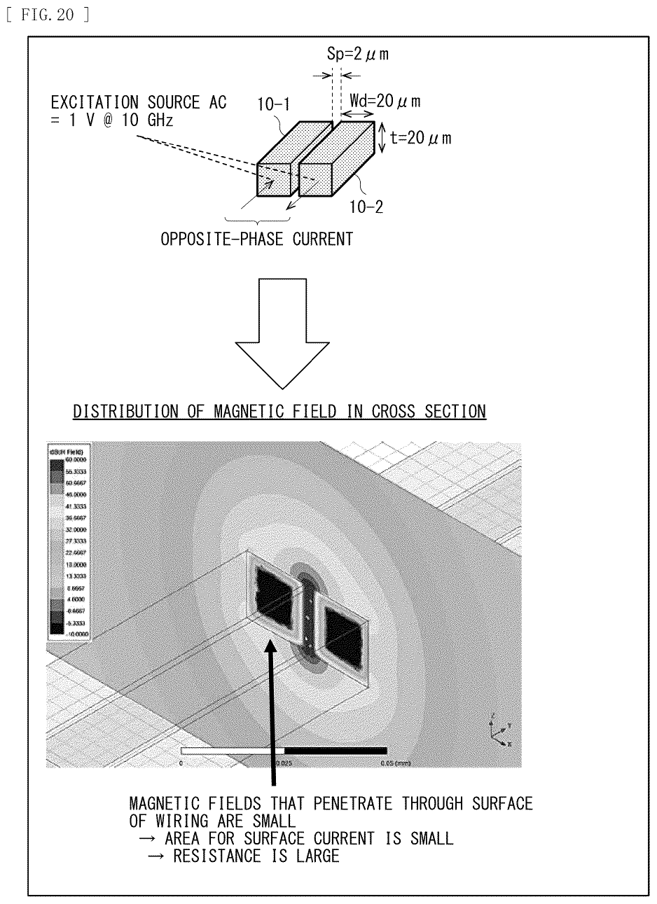

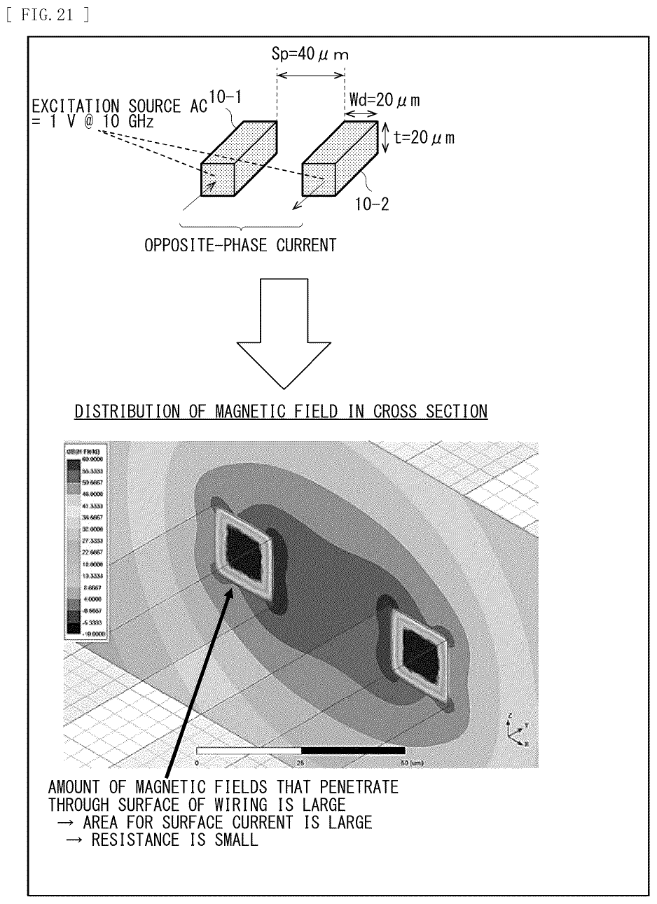

FIGS. 20 and 21 show results of simulation, using electromagnetic field analysis, for the distribution of magnetic fields in the cross section of the wiring in a case where an opposite-phase current is caused to flow through two division wirings 10-1 and 10-2. FIG. 20 shows results in a case where the interwire space Sp is 2 μm. FIG. 21 shows results in a case where the interwire space Sp is 40 μm. During the simulation, two division wirings 10-1 and 10-2 having the wiring width Wd=20 μm and the wiring thickness t=20 μm are disposed, and an opposite-phase current is applied by setting an excitation source to a potential difference of AC voltage AC=1 V and the frequency f=10 GHz.

In a case where the opposite-phase current is caused to flow and the two division wirings 10-1 and 10-2 are disposed close to each other, electromagnetic fields are trapped due to the closeness of a return current to reduce the spread of the electromagnetic fields. Thus, the magnetic fields generated by the current flowing through the division wirings 10-1 and 10-2 work between the wirings in a direction in which they are made strengthened. For this reason, as the interwire space Sp is smaller as illustrated in FIG. 20, the magnetic fields concentrate more on between the wirings, and most of the current only flows through this area. This leads to a reduction in the magnetic fields penetrating through the front surface of the wiring, and reduces the area for the surface current. This results in an increase in the resistance. In contrast, if the interwire space Sp increases as illustrated in FIG. 21, this phenomenon becomes less pronounced. In addition, magnetic fields penetrating through the surface of the wiring increase, which leads to an increase in the area for the surface current. This results in a reduction in the resistance.

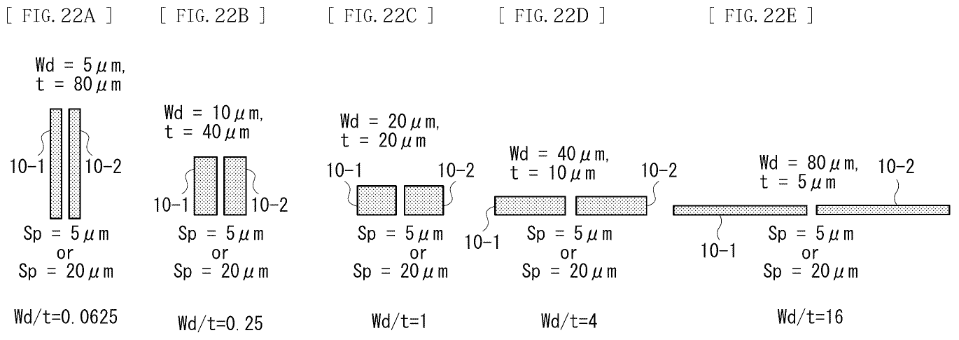

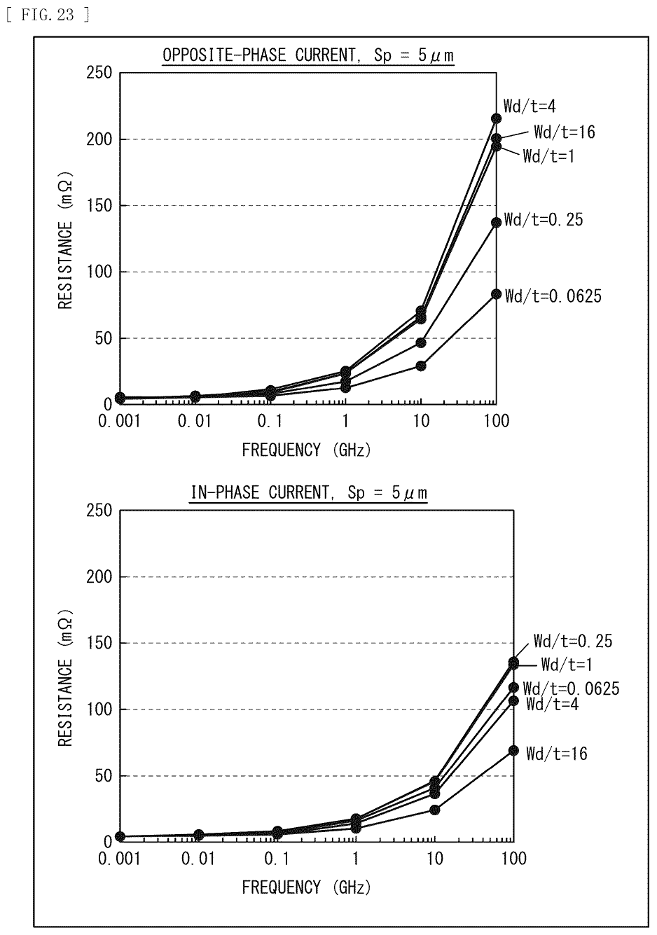

FIG. 22 shows a plurality of configuration examples in which the area (Wd×t) of cross-section of each of two division wirings 10-1 and 10-2 is constant (Wd×t=400 μm²) and a ratio (Wd/t) between the wiring width (individual wiring width Wd) and the wiring thickness t is varied. As the plurality of configuration examples, FIG. 22 shows the configuration examples of: Wd=5 μm and t=80 μm ((A) in FIG. 22); Wd=10 μm and t=40 μm ((B) in FIG. 22); Wd=20 μm and t=20 μm ((C) in FIG. 22); Wd=40 μm and t=10 μm ((D) in FIG. 22); and Wd=80 μm and t=5 μm ((E) in FIG. 22).

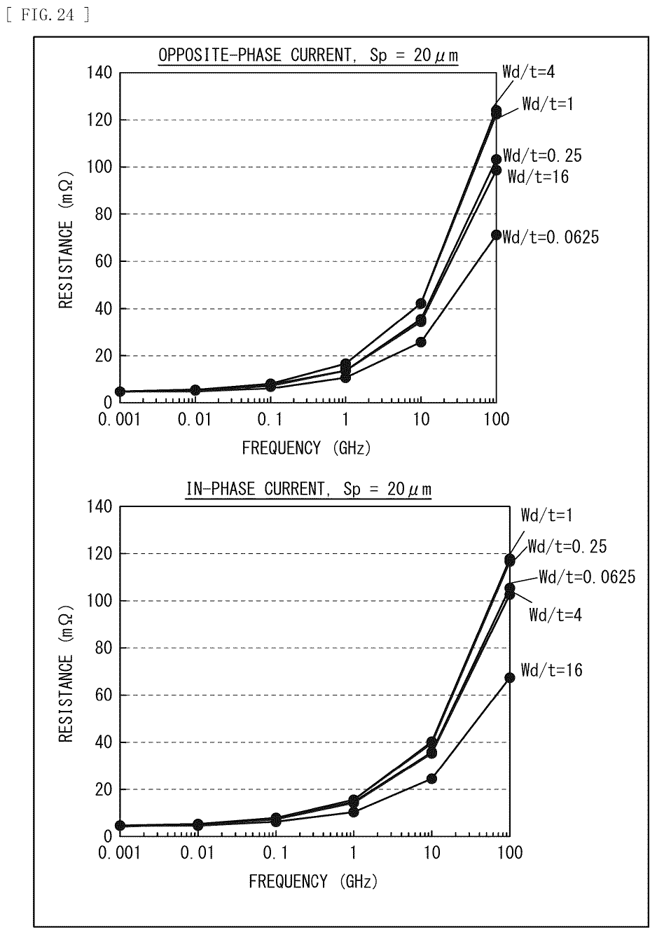

FIGS. 23 and 24 show results of simulation for resistances in terms of the frequency property using electromagnetic field analysis for each of the configuration examples illustrated in FIG. 22. In FIGS. 23 and 24, the horizontal axis indicates the frequency f and the vertical axis indicates the resistance (Rdc+Rac). FIG. 23 shows results of simulation for each of the configuration examples illustrated in FIG. 22, in which the interwire space Sp is set to 5 μm, an opposite-phase current is caused to flow through the two division wirings 10-1 and 10-2, and an in-phase current is caused to flow. FIG. 24 shows results of simulation for each of the configuration examples illustrated in FIG. 22, in which the interwire space Sp is set to 20 μm, an opposite-phase current is caused to flow through the two division wirings 10-1 and 10-2, and an in-phase current is caused to flow.

From the results in FIGS. 23 and 24, it can be understood that, as the coupling area (Sp×t) between wirings increases (Wd/t reduces), the resistance of the wire line in a case where the opposite-phase current is caused to flow tends to reduce. In addition, it can be understood that, as the coupling area (Sp×t) between wirings reduces (Wd/t increases), the resistance of the wire line in a case where the in-phase current is caused to flow tends to reduce. The tendency of the properties in the results in FIGS. 23 and 24 matches the theory described using FIGS. 18 to 21.

From the results described above, it is desirable to set, for example, Wd/t=1 or less in a case where the opposite-phase current is caused to flow without considering the routing resource or the interwire space Sp that will be described later. In addition, in a case where the in-phase current is caused to flow, it is desirable to set, for example, Wd/t=1 or higher.

(1.2.2 Expression of Calculating Alternating-Current Resistance while Considering Interwire Space)

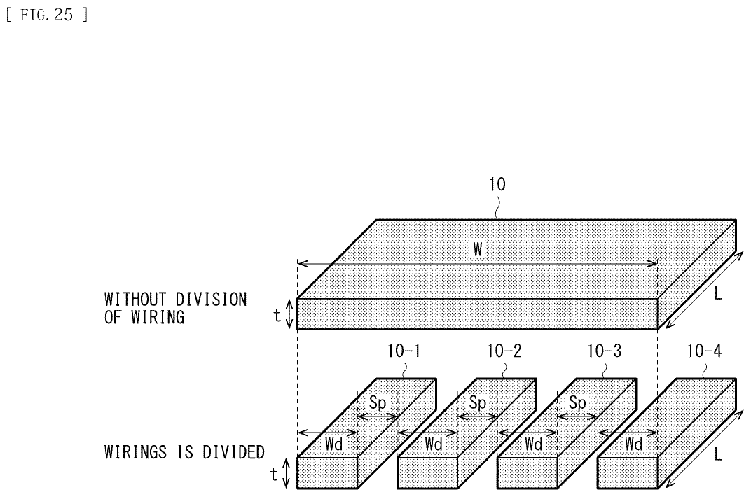

FIG. 25 shows the configuration example in which the wiring 10 is divided into four division wirings 10-1, 10-2, 10-3, and 10-4 (the number N of divisions of wirings=4).

The resistance of the wiring 10 is expressed as “direct-current resistance Rdc+alternating-current resistance Rac.” The direct-current resistance Rdc is expressed in the following manner.

$$Rdc = ( 1 / σ Wt ) \cdot L$$

For a case where the wiring is divided and a case where the wiring is not divided, the alternating-current resistance Rac is expressed by following Equations (6) and (7), respectively. Note that the parameters in the Expressions are as follows (see FIG. 25):
W: wiring width (entire width) (m)
Wd: individual wiring width (m) of division wiring
Sp: space (m) between wirings
t: wiring thickness (m)
L: wiring length (m)
N: the number of divisions of wirings (two or higher)
σ: electric conductivity (S/m) of wiring
f: operation frequency (frequency of alternating current) (GHz)
A0, A1, B0, B1, C0, C1: coefficient relating to the shape of wiring

### <Without Division of Wiring>

$$Rac = \{ ( A 0 * ( √ f \} * \{ ( B 0 * {W}^{B 1} ) \} * \{ 1 / ( σ * 58 e 6 ) \} * \{ L / ( 100 e - 6 ) \} \qquad ( 6 )$$

Here, (A0*(√f) is a term on which the wiring thickness t, the wiring width W, and the frequency f have an influence. (B0*W^{B1}) is a term on which the wiring thickness t and the wiring width W have an influence. 1/(σ*58e6) is a term on which the electric conductivity σ used for the wiring 10 has an influence. L/(100e−6) is a term on which the wiring length L has an influence.

### <With Division of Wiring>

$$Rac = \{ ( A 0 * Ln ( Sp / Wd ) + A 1 ) * ( √ f \} * \{ ( B 0 * {( Sp / Wd )}^{B 1} * {N}^{( C 0 * Ln ( Sp / Wd ) + C 1 )} \} * \{ 1 / ( σ * 58 e 6 ) \} * \{ L / ( 100 e - 6 ) \} * 0.5 \qquad ( 7 )$$

Here, {(A0*Ln (Sp/Wd)+A1)*(√f)} is a term (first term) on which the wiring thickness t, the interwire space Sp, and the frequency f have an influence. {(B0*(Sp/Wd) B1*N (C0*Ln (Sp/Wd)+C1)} is a term (second term) on which the wiring thickness t, the interwire space Sp, and the number N of divisions of wirings have an influence. {1/(σ*58e6)} is a term (third term) on which the electric conductivity σ used for the wiring 10 has an influence. {L/(100e−6)} is a term (fourth term) on which the wiring length L has an influence. Note that any of 1, 0.75, 0.5, and 0.25 is used for (Sp/Wd). A0, A1, B0, B1, C0, and C1 are fitting parameters that are dependent on the individual wiring width Wd and the wiring thickness t.

In a case where the wiring is divided, the influence of the interwire space Sp needs to be considered for the alternating-current resistance Rac as described above. In Equation (7), this is taken into consideration by incorporating the first term and the second term. On the basis of Equation (7), it is possible to obtain the number N of divisions of wirings or the like that makes the resistance value small.

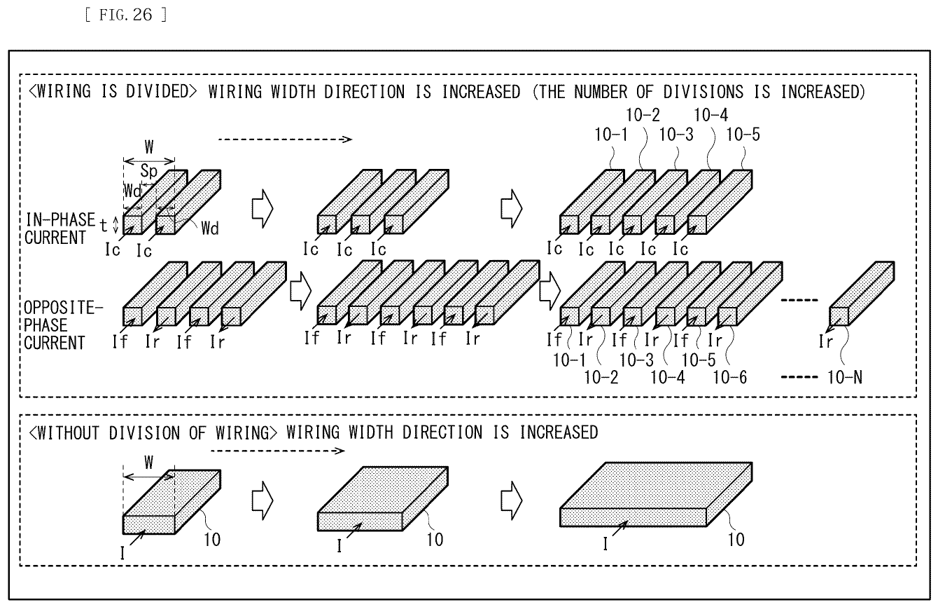

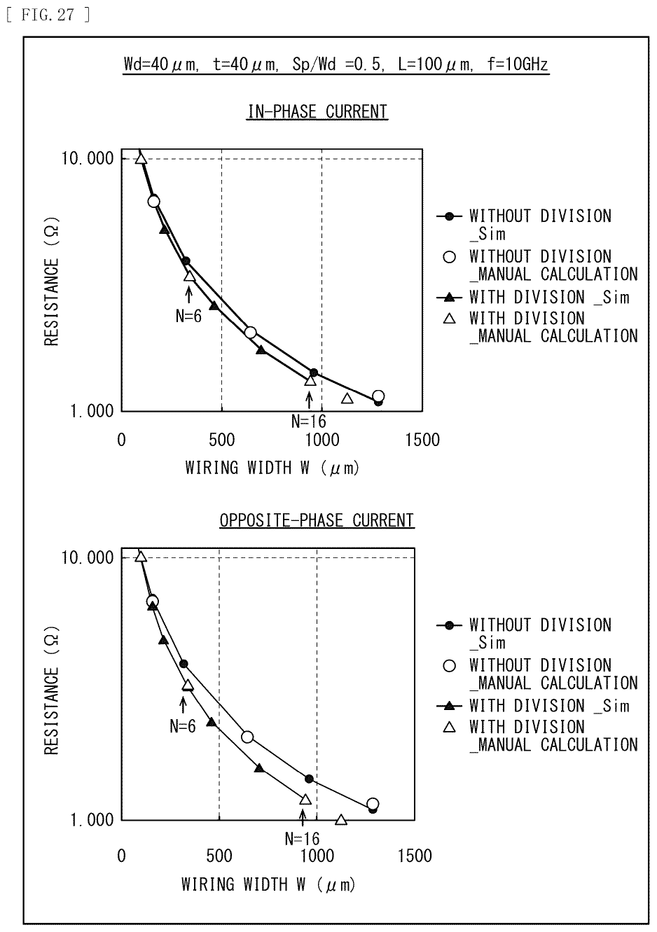

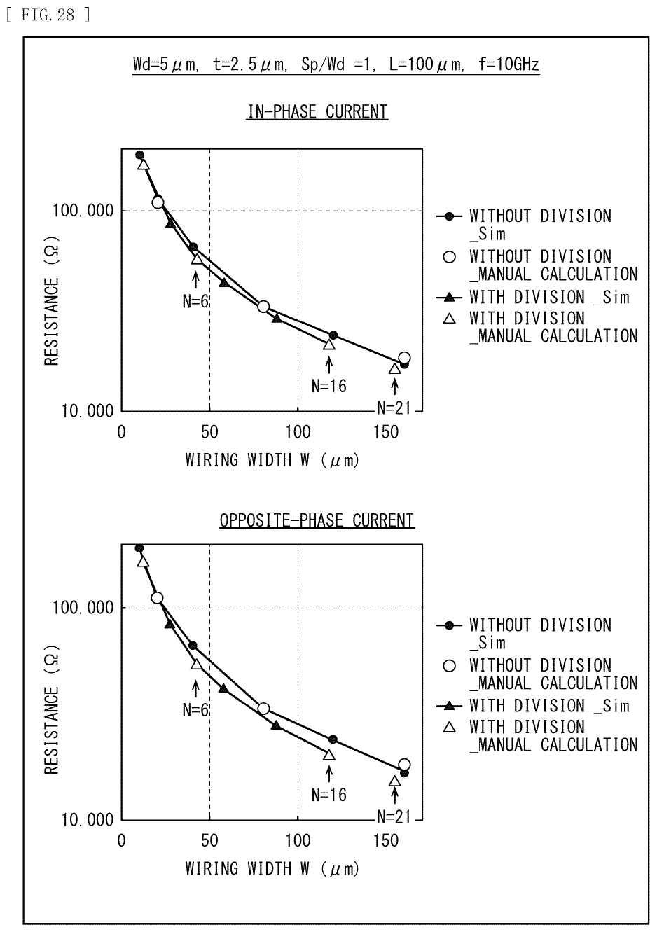

In order to confirm the adequacy of the resistance calculated through Equations (6) and (7), wiring models are created, and resistances are calculated through manual calculation and simulation using electromagnetic field analysis to compare them. FIG. 26 schematically illustrates wiring models used in calculation of the resistances. FIGS. 27 to 29 show results of calculation of the resistances through manual calculation and through simulation (Sim) using electromagnetic field analysis, by using the wiring models illustrated in FIG. 26. In FIGS. 27 to 29, the horizontal axis indicates the wiring width W and the vertical axis indicates the resistance R(=Rdc+Rac).

For the wiring models, a model without division of the wiring and a model in which the wiring is divided are created, and the resistance is calculated for cases where an in-phase current and an opposite-phase current are caused to flow. FIG. 26 schematically shows wiring models in which the wiring width W is increased for a case where the wiring is not divided and a case where the wiring is divided. In a case where the wiring is divided, as the wiring width Wis increased, the number N of divisions of wirings also increases, and a plurality of division wirings 10-1, 10-2, 10-3, . . . , and 10-N is formed.

A potential difference of AC voltage AC=1 V is applied to the wiring 10, and the resistance is calculated using the total electric current. In a case where the wiring is divided, the resistance R(=Rdc+Rac) is expressed in the following manner. “Ic” represents the in-phase current. “If” and “Ir” represent the opposite-phase current. “I” represents a current without division of the wiring.
In-phase current: R=V/ΣIc
Opposite-phase current: R=V/ΣIf (the electric current value of Ir is not the target, and the same Wd+Sp as the in-phase current is used)

In a case where the wiring is not divided, the resistance R(=Rdc+Rac) is expressed in the following manner.

$$R = V / I$$

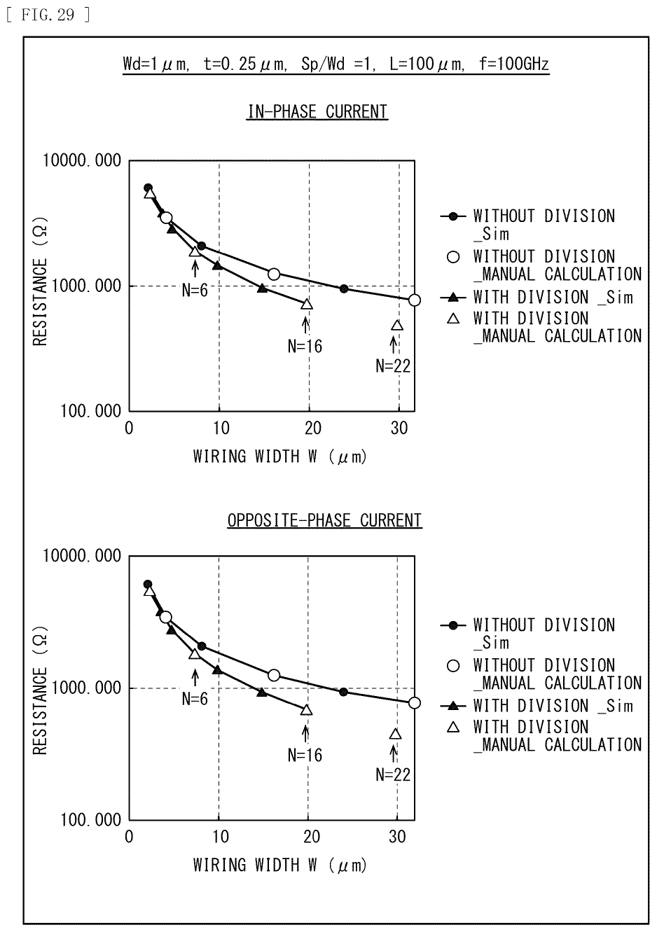

FIG. 27 shows results of calculation in a case where the shape of the wiring is set to the individual wiring width Wd=40 μm, the wiring thickness t=40 μm, the ratio between the interwire space Sp and the individual wiring width Wd of Sp/Wd=0.5, and the wiring length L=100 μm with the frequency f=10 GHz. FIG. 28 shows results of calculation in a case where the shape of the wiring is set to the individual wiring width Wd=5 μm, the wiring thickness t=2.5 μm, Sp/Wd=1, the wiring length L=100 μm with the frequency f=10 GHz. FIG. 29 shows results of calculation in a case where the shape of the wiring is set to the individual wiring width Wd=1 μm, the wiring thickness t=0.25 μm, Sp/Wd=1, and the wiring length L=100 μm with the frequency f=100 GHz.

As illustrated in FIGS. 27 to 29, the results obtained through manual calculation and the results obtained through simulation using electromagnetic field analysis show almost the same values. Note that the cases of FIGS. 27 to 29 employ conditions (the wiring modes and the operation frequencies) in which the values in a case where the wiring is divided are smaller than those in a case where the wiring is not divided. However, depending on the condition, the resistance in a case where the wiring is not divided may be smaller. Note that, here, in the example of calculation, Sp/Wd is set to 1, 0.75, 0.5, and 0.25, and values of the fitting parameters of A0, A1, B0, B1, C0, and C1 are used. However, it may be possible to set Sp/Wd to any given value to perform calculation.

### (1.2.3 Method of Efficiently Determining the Number of Divisions of Wirings)

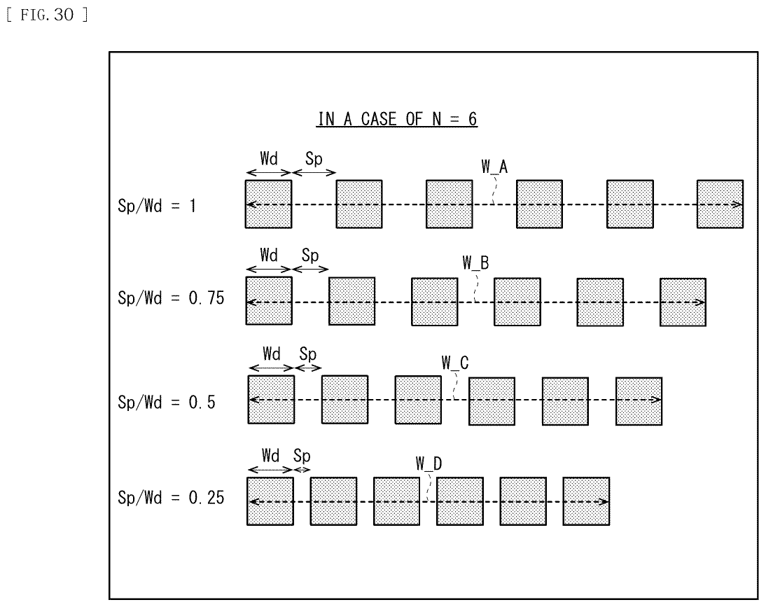

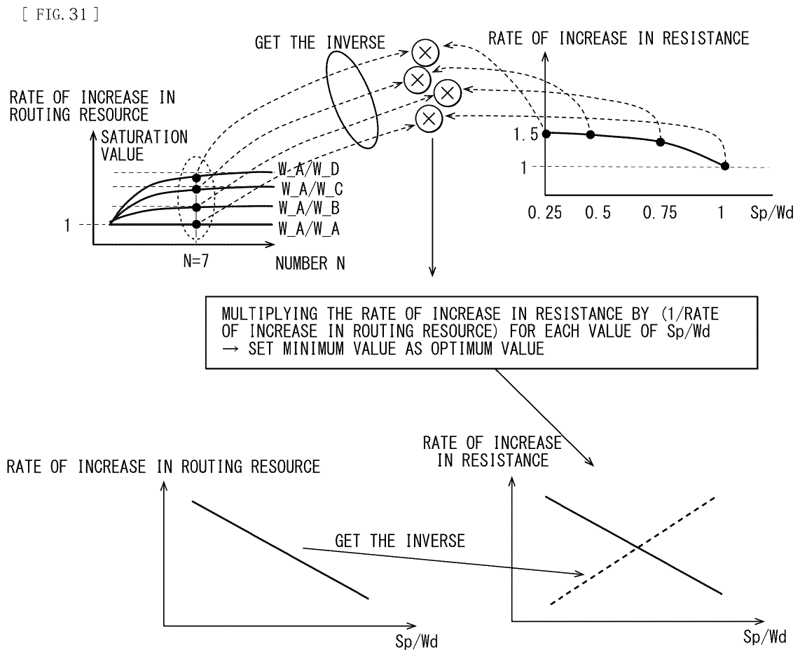

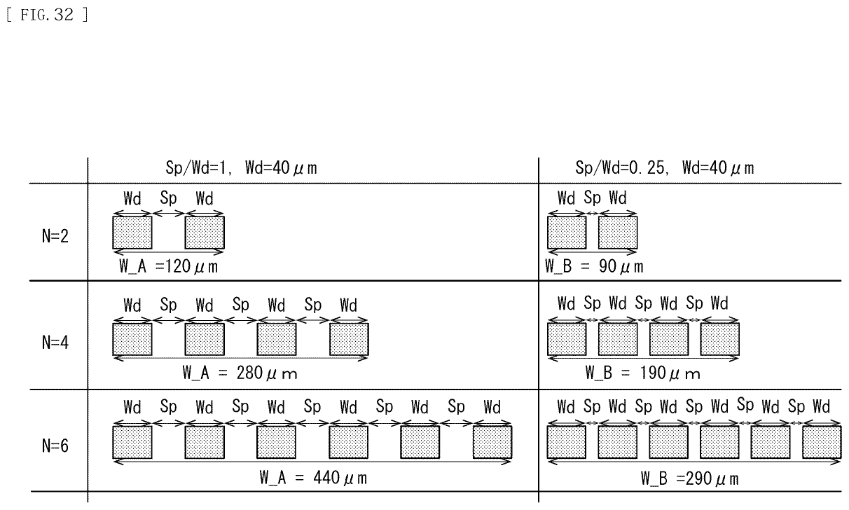

FIG. 30 illustrates the configuration example of the division wiring with various types of ratio (Sp/Wd) between the interwire space Sp and the individual wiring width Wd. FIG. 30 shows an example in which the wiring 10 includes six division wirings 10-1, 10-2, 10-3, 10-4, 10-5, and 10-6 with the number N of divisions of wirings=6. FIG. 31 shows the outline of a method of calculating an optimum value of Sp/Wd for reducing the alternating-current resistance Rac on the basis the relationship between the number N of divisions of wirings, the interwire space Sp, the individual wiring width Wd, and the wiring thickness t.

The optimum Sp/Wd for reducing the alternating-current resistance Rac can be calculated in the following procedure, for example.
Procedure 1. Calculate the number N of divisions of wirings and the rate of increase in the routing resource while considering the routing resource in the width direction.
Procedure 2. Calculate the rate of increase in the resistance that makes Sp/Wd small.
Procedure 3. Calculate the optimum Sp/Wd while considering the results of procedures 1 and 2.

As Sp/Wd increases, the alternating-current resistance reduces. In addition, as the number N of divisions of wirings increases, the surface area increases, which makes the resistance more likely to reduce. In a case where the Sp/Wd reduces and the number N of divisions of wirings increases, the routing resource increases. Thus, it is not preferable to excessively increase the number N of divisions of wirings. Here, as illustrated in FIG. 30, W_A represents the entire width of the wiring 10 at the time of Sp/Wd=1. W_B represents the entire width of the wiring 10 at the time of Sp/Wd=0.75. W_C represents the entire width of the wiring 10 at the time of Sp/Wd=0.5. W_D represents the entire width of the wiring 10 at the time of Sp/Wd=0.25. In this case, the rate of increase in the routing resource in the width direction is defined as W_A/W_B, W_A/W_C, and W_A/W_D. As illustrated in FIG. 31, in a case where the number N of divisions of wirings is increased, the rate of increase in the routing resource becomes saturated, and becomes flattened at a certain value. It can be said that efficiency relative to the routing resource increases if the number N of divisions of wirings is close to saturation. In the example of FIG. 31, it is saturated at N=7, for example. In addition, for example, the rate of increase in the routing resource becomes saturated at W_A/W_D=1.5. In a case of the configuration of W_D, the routing resource is not very consumed. However, the interwire space Sp is small, and hence, the alternating-current resistance Rac is large. From the viewpoint of the relationship between the number N of divisions of wirings and the rate of increase in the routing resource, the alternating-current resistance Rac increases in association with a reduction in the interwire space Sp.

Furthermore, in the example of FIG. 31, at the time of Sp/Wd=0.25, the rate of increase in the resistance is 1.5, and the alternating-current resistance Rac is 1.5 times higher than that when Sp/Wd=1. In terms of the relationship between Sp/Wd and the rate of increase in the resistance, the alternating-current resistance Rac reduces as the interwire space Sp increases. Thus, for example, as illustrated in FIG. 31, the optimum value of Sp/Wd is set to the minimum value of the results of multiplying the inverse (1/the rate of increase in the routing resource) of the rate of increase in the routing resource for each of the values of Sp/Wd by the rate of increase in the resistance.

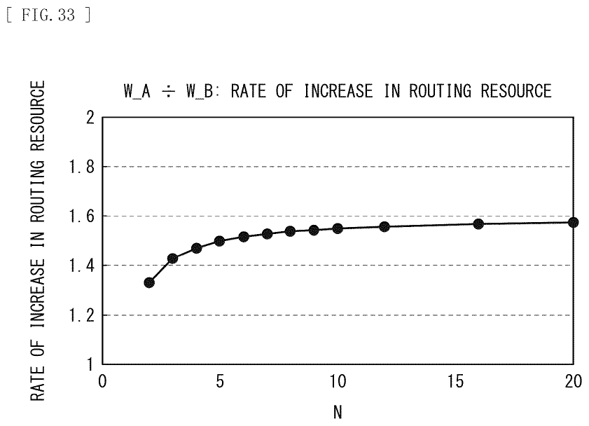

FIGS. 32 and 33 show examples of calculation of the number N of divisions of wirings and the rate of increase in the routing resource with the routing resource in the width direction through the procedure 1 described above being taken into consideration.

FIGS. 32 and 33 show an example of the individual wiring width Wd=40 μm. In addition, the routing resource in a case of Sp/Wd=1 is set to W_A, and the routing resource in a case of Sp/Wd=0.25 is set to W_B. The rate of increase in the routing resource is defined as W_A÷W_B. The rate of increase in the routing source in a case where the number N of divisions of wirings is increased is shown in FIG. 33.

As the frequency f increases, the alternating-current resistance Rac increases. In order to suppress problems of power consumption, heat generation, and the like, it is desired to reduce the alternating-current resistance Rac at a portion of the wiring that is operated at high frequencies. Description will be made of a method of effectively reducing the alternating-current resistance Rac of the wiring 10 after division. In a case where the routing resource for the Sp/Wd=1 is set to W_A and the routing resource for the Sp/Wd=0.25 is set to W_B, the interwire space Sp in a case of W_B is smaller. Thus, it is possible to dispose more wirings 10 within a limited routing resource. As illustrated in FIG. 33, as the number N of divisions of wirings increases, the rate of increase in the routing resource tends to get saturated, and actually gets saturated at or around the number N of divisions of wirings=5. The rate of increase in the routing resource at this time is about 1.5. From the viewpoint of reducing the alternating-current resistance Rac, it is desirable to use a value at which the number N of divisions of wirings starts to get saturated. Thus, it is preferable to use the number N of divisions of wirings=4 or higher, preferably the number of divisions of wirings 5 or higher. In addition to Sp/Wd=0.25, Sp/Wd=0.5 and 0.75 also exhibit the same tendency with W_B (the ratio is fixed to Sp/Wd=1 in a case of W_A).

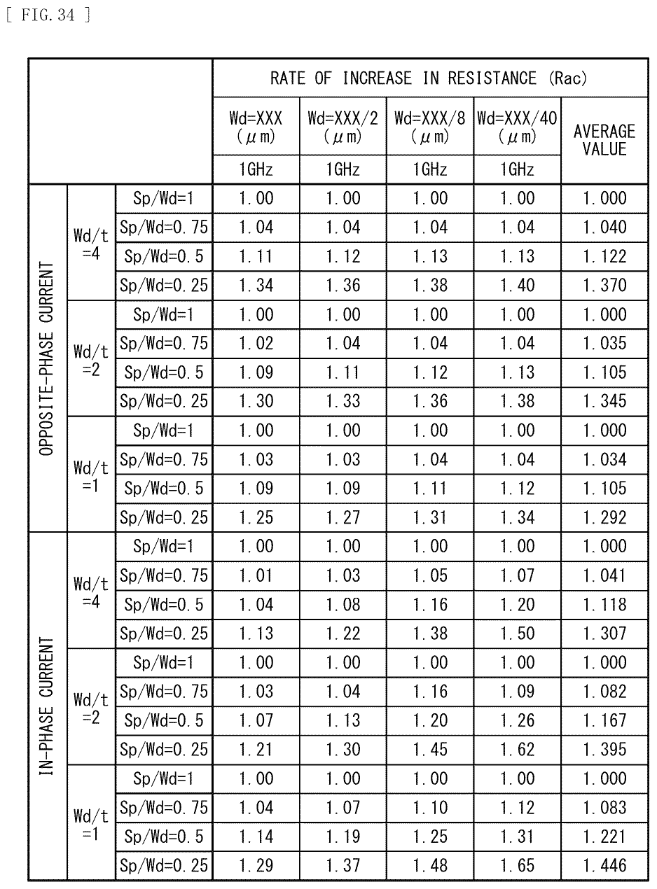

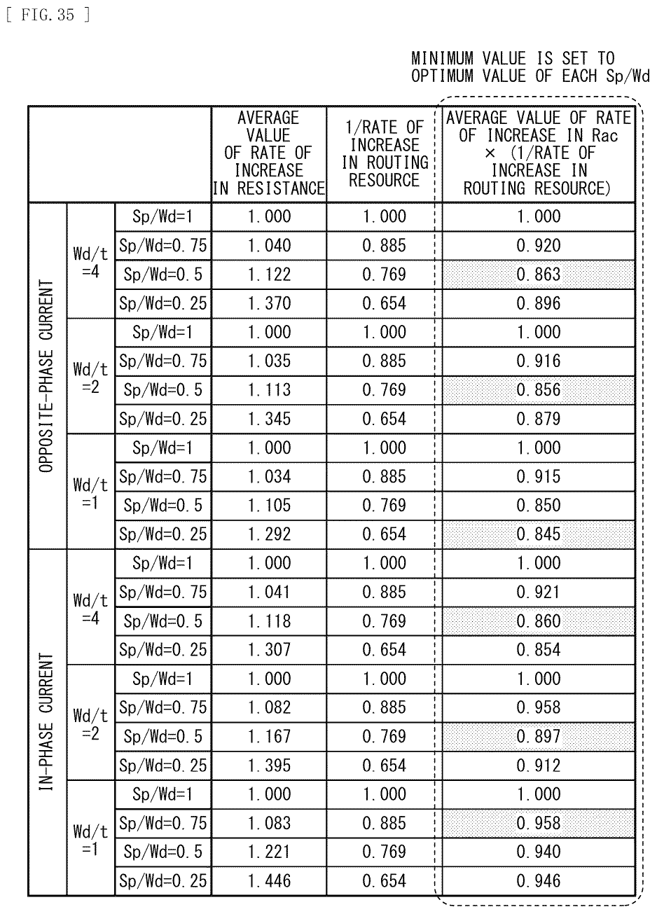

FIG. 34 shows one example of results of calculation of the rate of increase in the resistance through the procedure 2 described above. FIG. 35 shows one example of results of calculation of multiplying the inverse (1/the rate of increase in the routing resource) of the rate of increase in the routing resource through the procedure 3 described above by the rate of increase in the resistance. As described above, the optimum value of Sp/Wd is set to the minimum value of results of multiplication of the inverse of the rate of the increase in the routing resource by the rate of increase in the resistance.

In the example of FIG. 34, the frequency f is set to 1 GHz. However, at the time of calculating the optimum value of Sp/Wd, the frequency f may be set to any given value as the resistance (Rdc+Rac) is proportional to the square root of the frequency f. In order to identify the tendency of Sp/Wd, calculation is made of the average value of values for each of the individual wiring width Wd (Wd=XXX, Wd=XXX/2, Wd=XXXX/8, Wd=XXXX/40) as the rate of increase in the resistance. “XXX” is 40 μm, for example.

FIG. 35 shows results of calculating the inverse of the rate of increase in the routing resource for Sp/Wd=0.75, Sp/Wd=0.5, and Sp/Wd=0.25 at the number N of divisions of wirings at which the rate of increase in the routing resource calculated through the methods illustrated in FIGS. 32 and 33 described above gets saturated, and also multiplying the average value of the rates of increase in the resistance by the inverse of the rate of increase in the routing resource. The minimum value of the results of multiplying the inverse of the rate of increase in the routing resource by the rate of increase in the resistance is the value that makes it possible to make the alternating-current resistance Rac small. Thus, the value of Sp/Wd corresponding to this minimum value is a desirable value of Sp/Wd. In the example of FIG. 35, the desirable values of Sp/Wd are obtained for values of Wd/t=0.25, 0.5, and 1.0.

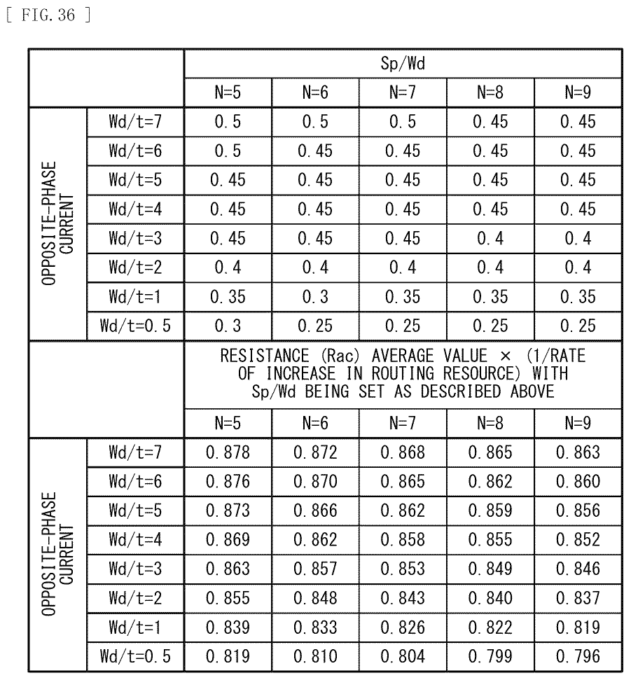

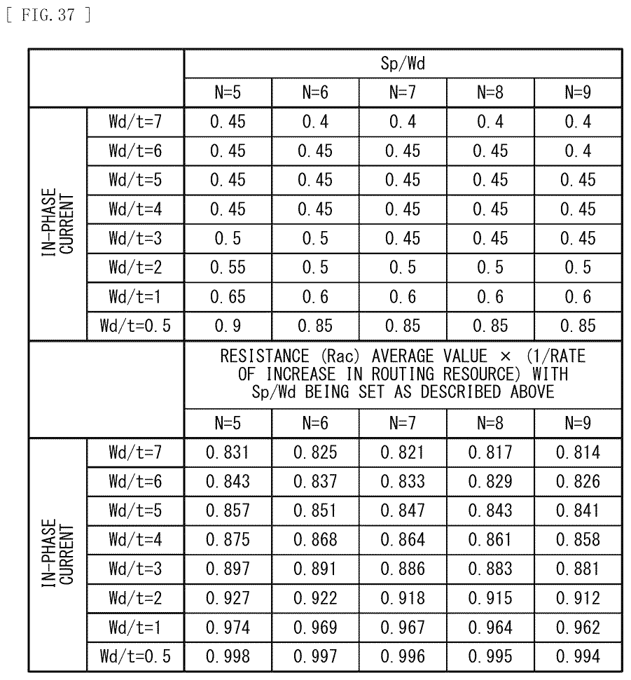

FIG. 36 shows one example of the relationship of the optimum values of the number N of divisions of wirings, the Sp/Wd, and the Wd/t in a case where an opposite-phase current is caused to flow. FIG. 37 shows one example of the relationship of the optimum values of the number N of divisions of wirings, the Sp/Wd, and the Wd/t in a case where an in-phase current is caused to flow.

In FIGS. 36 and 37, the individual wiring width Wd are set to given values. From the viewpoints of the routing resource and the rate of increase in the resistance and on the basis of the results described above as well as the results of FIGS. 36 and 37, it is desirable that the wiring 10 be divided so as to satisfy the following conditions in order to efficiently reduce the alternating-current resistance Rac occurring due to the skin effect. It is assumed that the individual wiring width Wd has any given value.
N: 4 or higher (preferably 5 or higher)
Wd/t: 0.5 to 6
Sp/Wd:
   0.2 to 0.55 in a case where an opposite-phase current is caused to flow, and
   0.35 to 0.95 in a case where an in-phase current is caused to flow.

Note that, as described above in a case where the routing resource or the interwire space Sp is not taken into consideration, Wd/t may have the following value.
In a case where an opposite-phase current is caused to flow, Wd/t=1 or less
In a case where an in-phase current is caused to flow, Wd/t=1 or higher

In addition, in order to obtain the effect of reducing the alternating-current resistance Rac, it is preferable to employ a structure in which the wiring 10 having wiring length L of 100 μm or higher is divided.

### [1.3 Application Example]

The wiring 10 according to the embodiment is applicable to various types of electronic apparatus. The wiring 10 according to the embodiment is applicable to general substrates at which divided wirings 10 can be formed. For example, it is possible to apply it to a printed circuit board (PCB), an electronic component, a semiconductor package, a semiconductor chip, or the like. In addition, it is possible to apply it to a wiring 10 through which an opposite-phase current or an in-phase current flows as an alternating current. Furthermore, it is possible to apply the wiring 10 to a signal wiring configured to transmit a data signal or clock signal. In addition, it is possible to apply the wiring 10 to a power-circuit wiring and a GND (ground) wiring. Furthermore, it is possible to form the divided wirings 10 at a surface layer and an internal layer.

FIG. 38 shows a first application example of the wiring according to the embodiment applied to an electronic apparatus.

FIG. 38 shows an example in which the divided wirings 10 are applied to a printed circuit board (PCB) 101. For example, it is possible to apply the wirings 10 divided through the technique according to the embodiment as a coupling wiring between a package 102 in which a semiconductor chip or the like is embedded at the printed circuit board (PCB) 101, and a component such as a package or a connector.

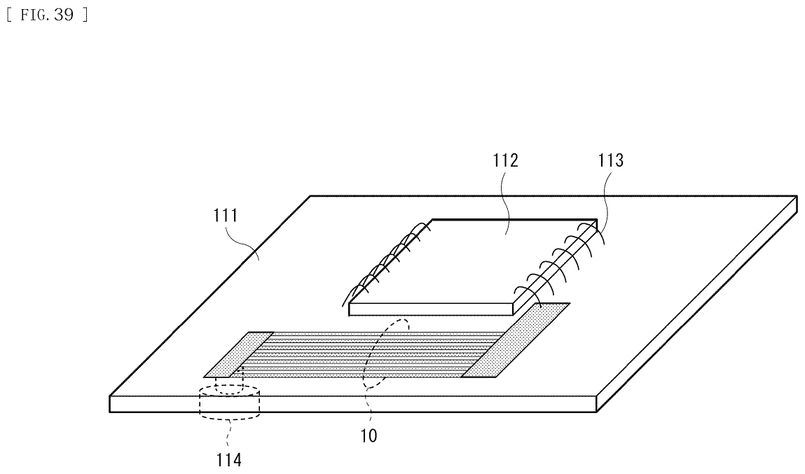

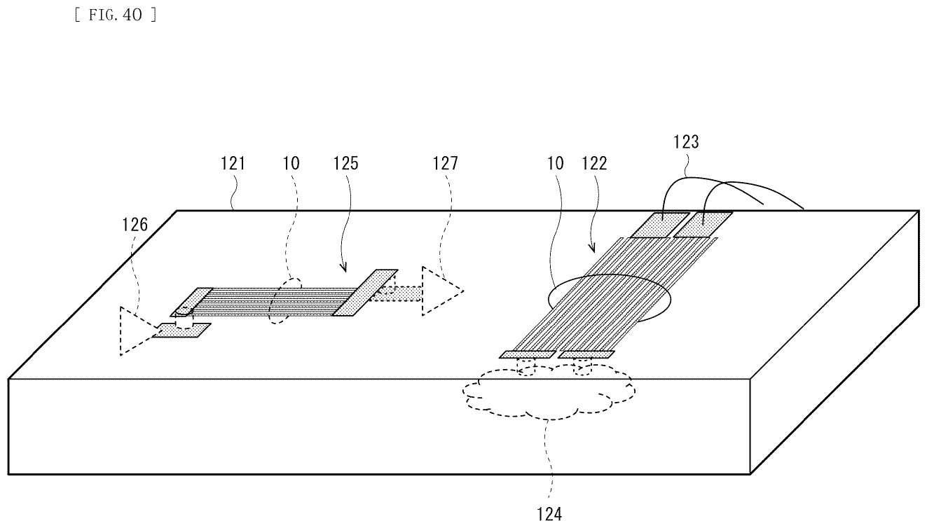

FIG. 39 shows a second application example of the wiring according to the embodiment applied to an electronic apparatus.

FIG. 39 shows an example in which the divided wirings 10 are applied to a package substrate 111. A semiconductor chip 112 is fixed at the package substrate 111, for example, through a bonding wire 113. For example, it is possible to apply the wirings 10 divided through the technique according to the embodiment as a couple wiring between the semiconductor chip 112 and a package output terminal 114.

FIG. 40 shows a third application example of the wiring according to the embodiment applied to an electronic apparatus.

FIG. 40 shows an example in which the divided wirings 10 are applied to a semiconductor chip 121. The semiconductor chip 121 is provided with a semiconductor circuit 124 that uses a power supply or consumes a GND current. The semiconductor circuit 124 is coupled to a power-supply wiring or a GND wiring 122. The power-supply wiring or the GND wiring 122 is coupled to a bonding wire 123. It is possible to apply the wirings 10 divided through the technique according to the embodiment as the power-supply wiring or the GND wiring 122.

Furthermore, the semiconductor chip 121 is provided with a transmission buffer 126 configured to transmit a clock signal or a data signal, and a reception buffer 127 configured to receive the clock signal or the data signal. The transmission buffer 126 and the reception buffer 127 are coupled to each other through a signal wiring 125. It is possible to apply the wirings 10 divided through the technique according to the embodiment as the signal wiring 125.

### [1.4 Effects]

As described above, with the technique according to the embodiment, the wiring 10 includes the plurality of division wirings, and the plurality of division wirings is optimized so as to be able to reduce an increase in the resistance due to the skin effect. This makes it possible to reduce the increase in the resistance in a high-frequency range due to the skin effect.

It is possible to suppress the increase in the resistance in a high-frequency range due to the skin effect by dividing the wiring 10 into a plurality of pieces to increase the surface area. The technique according to the embodiment optimizes the configuration parameters at the time of dividing the wiring 10 into a plurality of pieces, the configuration parameters including the number N of divisions of wirings, the individual wiring width Wd of each of the wirings 10 after division, the interwire space Sp, or the like. This makes it possible to sufficiently suppress the increase in the resistance in a high-frequency range. By applying the technique according to the embodiment to a substrate, a package, a semiconductor chip, or the like to design the wiring, it is possible to reduce the resistance of the wiring at the substrate, the package, the semiconductor chip, and the like. This makes it possible to reduce the generated heat or voltage drop due to effective electric power generated at these components.

Note that the effects described in the present description are merely examples, and are not given for the purpose of limitation, and other effects may be possible. This similarly applies to effects of the other embodiments described below.

### 2. Other Embodiments

The technique according to the present disclosure is not limited to the description of the embodiment described above, and various modifications and implementations are possible.

For example, the present technology is able to take the following configurations. With the present technology having the following configurations, the wiring includes a plurality of division wirings, and the plurality of division wirings is optimized so as to be able to reduce the increase in the resistance due to the skin effect. This makes it possible to reduce the increase in the resistance in a high-frequency range due to the skin effect.

(1)

A wiring including a plurality of division wirings, each of which allows an alternating current to flow through, in which
the number of divisions of the plurality of division wirings is equal to or more than four, and
when Sp is an interwire space between two adjacent division wirings of the division wirings and Wd is an individual wiring width of each of the plurality of division wirings, Sp/Wd falls in a range of not less than 0.2 and not more than 0.55 in a case where an opposite-phase current is caused to flow through the plurality of division wirings as the alternating current, and Sp/Wd falls in a range of not less than 0.35 and not more than 0.95 in a case where an in-phase current is caused to flow through the plurality of division wirings as the alternating current.
   (2)

The wiring according to (1) described above, in which
Wd/t falls in a range of not less than 0.5 and not more than 6, where Wd is an individual wiring width of each of the plurality of division wirings, and t is a wiring thickness of each of the plurality of division wirings.
   (3)

The wiring according to (1) or (2) described above, in which
an opposite-phase current is configured to flow through the plurality of division wirings as the alternating current, and
Wd/t is equal to or less than 1, where Wd is an individual wiring width of each of the plurality of division wirings, and t is a wiring thickness of each of the plurality of division wirings.
   (4)

The wiring according to (1) or (2) described above, in which
an in-phase current is configured to flow through the plurality of division wirings as the alternating current, and
Wd/t is equal to or more than 1, where Wd is an individual wiring width of each of the plurality of division wirings, and t is a wiring thickness of each of the plurality of division wirings.
   (5)

The wiring according to any one of (1) to (4) described above, in which
the number of divisions of wirings is obtained on a basis of an expression used to calculate an alternating-current resistance, the expression including:
a term influenced by a wiring thickness of each of the plurality of division wirings, the interwire space, and a frequency of the alternating current; and
a term influenced by the wiring thickness, the interwire space, and the number of divisions of wirings.
   (6)

The wiring according to any one of (1) to (5) described above, in which a wiring length of each of the plurality of division wirings is equal to or more than 100 μm.

(7)

The wiring according to any one of (1) to (6) described above, in which the plurality of division wirings is used as a signal wiring.

(8)

The wiring according to any one of (1) to (6) described above, in which the plurality of division wirings is used as a power-supply wiring.

(9)

The wiring according to any one of (1) to (6) described above, in which the plurality of division wirings is used as a ground wiring.

(10)

An electronic apparatus including a wiring including a plurality of division wirings, each of
which allows an alternating current to flow through, in which
the number of divisions of the plurality of division wirings is equal to or more than four, and when Sp is an interwire space between two adjacent division wirings of the division wirings and Wd is an individual wiring width of each of the plurality of division wirings, Sp/Wd falls in a range of not less than 0.2 and not more than 0.55 in a case where an opposite-phase current is caused to flow through the plurality of division wirings as the alternating current, and Sp/Wd falls in a range of not less than 0.35 and not more than 0.95 in a case where an in-phase current is caused to flow through the plurality of division wirings as the alternating current.

This application claims priority based on Japanese Patent Application No. 2022-163363 filed on Oct. 11, 2022 with Japan Patent Office, the entire contents of which are incorporated in this application by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A wiring comprising a plurality of division wirings, each of which allows an alternating current to flow through, wherein
the number of divisions of the plurality of division wirings is equal to or more than four, and
when Sp is an interwire space between two adjacent division wirings of the division wirings and Wd is an individual wiring width of each of the plurality of division wirings, Sp/Wd falls in a range of not less than 0.2 and not more than 0.55 in a case where an opposite-phase current is caused to flow through the plurality of division wirings as the alternating current, and Sp/Wd falls in a range of not less than 0.35 and not more than 0.95 in a case where an in-phase current is caused to flow through the plurality of division wirings as the alternating current.

2. The wiring according to claim 1, wherein
Wd/t falls in a range of not less than 0.5 and not more than 6, where Wd is an individual wiring width of each of the plurality of division wirings, and t is a wiring thickness of each of the plurality of division wirings.

3. The wiring according to claim 1, wherein
an opposite-phase current is configured to flow through the plurality of division wirings as the alternating current, and
Wd/t is equal to or less than 1, where Wd is an individual wiring width of each of the plurality of division wirings, and t is a wiring thickness of each of the plurality of division wirings.

4. The wiring according to claim 1, wherein
an in-phase current is configured to flow through the plurality of division wirings as the alternating current, and
Wd/t is equal to or more than 1, where Wd is an individual wiring width of each of the plurality of division wirings, and t is a wiring thickness of each of the plurality of division wirings.

5. The wiring according to claim 1, wherein
the number of divisions of wirings is obtained on a basis of an expression used to calculate an alternating-current resistance, the expression including:
a term influenced by a wiring thickness of each of the plurality of division wirings, the interwire space, and a frequency of the alternating current; and
a term influenced by the wiring thickness, the interwire space, and the number of divisions of wirings.

6. The wiring according to claim 1, wherein a wiring length of each of the plurality of division wirings is equal to or more than 100 μm.

7. The wiring according to claim 1, wherein the plurality of division wirings is used as a signal wiring.

8. The wiring according to claim 1, wherein the plurality of division wirings is used as a power-supply wiring.

9. The wiring according to claim 1, wherein the plurality of division wirings is used as a ground wiring.

10. An electronic apparatus comprising a wiring including a plurality of division wirings, each of which allows an alternating current to flow through, wherein
the number of divisions of the plurality of division wirings is equal to or more than four, and
when Sp is an interwire space between two adjacent division wirings of the division wirings and Wd is an individual wiring width of each of the plurality of division wirings, Sp/Wd falls in a range of not less than 0.2 and not more than 0.55 in a case where an opposite-phase current is caused to flow through the plurality of division wirings as the alternating current, and Sp/Wd falls in a range of not less than 0.35 and not more than 0.95 in a case where an in-phase current is caused to flow through the plurality of division wirings as the alternating current.
